(19) United States
(12) Patent Application Publication
(10) Pub. No.: US 2022/0261928 A1
(43) Pub. Date: Aug. 18, 2022

(54) CROP YIELD FORECASTING MODELS

(71) Applicant: Indigo Ag, Inc., Boston, MA (US)

(72) Inventors: Nicholas Malizia, Boston, MA (US); Ying Xu, Boston, MA (US); Jonathon Bechtel, Boston, MA (US); Mark Friedl, Boston, MA (US)

(21) Appl. No.: 17/625,287

(22) PCT Filed: Jul. 8, 2020
(86) PCT No.: PCT/US20/41256

§ 371 Date: Jan. 6, 2022

Related U.S. Application Data
(60) Provisional application No. 62/871,674, filed on Jul. 8, 2019.

(51) Int. Cl. G06Q 50/02; G06V 20/13; G06V 20/10; G06V 10/62; G06N 20/20; G06N 5/00

(52) U.S. Cl. CPC G06Q 50/02; G06V 20/13; G06N 5/003; G06V 10/62; G06N 20/20; G06V 20/188

(57) ABSTRACT

Methods of and computer program products for predicting crop yield of a geographic region are provided. In various embodiments, a time series of satellite imagery is received. The time series of satellite imagery covers at least the geographic region during a predetermined time period. The predetermined time period comprises one or more phenology periods. A time series of weather data is received. The time series of weather data covers at least the geographic region during the predetermined time period. At least one surface feature of the geographic region during each of the one or more phenology periods is generated from the time series of satellite imagery. At least one weather feature of the geographic region during each of the one or more phenology periods is generated from the time series of weather data. The at least one surface feature and the at least one weather feature are provided to a trained model. A prediction of crop yield for the geographical region is received from the trained model.

### CROSS-REFERENCE TO RELATED APPLICATIONS

This application claims the benefit of U.S. Provisional Application No. 62/871,674, filed Jul. 8, 2019, which is hereby incorporated by reference in its entirety.

### BACKGROUND

Embodiments of the present disclosure relate to agricultural data analytics, and more specifically, to crop yield forecasting models, for example for corn and soy.

### BRIEF SUMMARY

According to embodiments of the present disclosure, methods of, systems for, and computer program products for predicting crop yield of a geographic region are provided. In various embodiments, a time series of satellite imagery is received. The time series of satellite imagery covers at least the geographic region during a predetermined time period. The predetermined time period comprises one or more phenology periods. A time series of weather data is received. The time series of weather data covers at least the geographic region during the predetermined time period. At least one surface feature of the geographic region during each of the one or more phenology periods is generated from the time series of satellite imagery. At least one weather feature of the geographic region during each of the one or more phenology periods is generated from the time series of weather data. The at least one surface feature and the at least one weather feature are provided to a trained model. A prediction of crop yield for the geographical region is received from the trained model.

In some embodiments, generating the at least one surface feature comprises generating summary data of the satellite imagery within the geographic region. In some embodiments, generating the at least one surface feature further comprises aggregating the summary data within each of the one or more phenology periods. In some embodiments, generating the at least one surface feature further comprises sampling a plurality of pixels of the satellite imagery within the geographic region and generating summary data therefrom. In some embodiments, the summary data comprises a maximum vegetation index.

In some embodiments, generating the at least one weather feature comprises generating summary data of the weather data within the geographic region. In some embodiments, generating the at least one weather feature further comprises aggregating the summary data within each of the one or more phenology periods.

In some embodiments, the trained model is a linear mixed-effects model. In some embodiments, the trained model is a trained learning system. In some embodiments, the trained learning system comprises a decision tree ensemble.

In some embodiments, each of the plurality of phenology periods correspond to a crop within the geographic region. In some embodiments, the crop comprises a cereal. In some embodiments, the cereal comprises wheat, rice, barley, buckwheat, rye, millet, oats, corn, sorghum, triticale, spelt, or sugar cane. In some embodiments, the crop comprises a dicot. In some embodiments, the dicot comprises cotton, canola, sunflower, tomato, lettuce, peppers, cucumber, endive, melon, potato, or soy.

In some embodiments, a prediction of crop yield is determined for at least one additional geographic region, and the prediction of crop yield for the geographical region and the prediction of crop yield for the at least one additional geographic region are aggregated. In some embodiments, aggregating comprises weighting the prediction of crop yield for the geographical region according to a size of the geographical region and weighting the prediction of crop yield for the at least one additional geographic region according to a size of the at least one additional geographic region. In some embodiments, aggregating comprises weighting the prediction of crop yield for the geographical region according to historical yield of the geographical region. In some embodiments, aggregating comprises weighting the prediction of crop yield for the geographical region according to crop production area within the geographical region and weighting the prediction of crop yield for the at least one additional geographic region according to crop production area of the at least one additional geographic region. In some embodiments, the crop production area is the number of acres harvested within a geographic region. In some embodiments, aggregating comprises weighting the prediction of crop yield for the geographical region according to an average size of the crop production area within that geographical region over previous years, for example the average crop production area over 3 years.

In some embodiments, the predetermined time period is divided into the one or more phenology periods based on the time series of satellite imagery. In some embodiments, dividing the predetermined time period comprises determining a time series of vegetation indices based on the time series of satellite imagery, and locating peaks in the time series of vegetation indices. In some embodiments, dividing the predetermined time period into the one or more phenology periods comprises: sampling a plurality of pixels of the time series of satellite imagery; determining a time series of vegetation indices based on the sampled pixels; and locating peaks in the time series of vegetation indices.

In some embodiments, the at least one surface feature and the at least one weather feature are selected based on the one or more phenology periods. In some embodiments, selecting the at least one surface feature and the at least one weather feature comprises determining a performance gain attributable to each of the at least one surface feature and the at least one weather feature for each of the one or more phenology periods. In some embodiments, determining the performance gain comprises applying a decision tree ensemble. In some embodiments, the one or more phenology periods comprise a plurality of phenology periods, and wherein the selection of the at least one surface feature and the at least one weather feature varies over the predetermined time period.

In some embodiments, a crop mask is applied to the time series of satellite imagery prior to generating the at least one surface feature.

### BRIEF DESCRIPTION OF THE SEVERAL VIEWS OF THE DRAWINGS

FIG. 1 is a schematic view of a data processing workflow according to embodiments of the present disclosure.

FIG. 2 is a graph of mean absolute percent error across the growing season for all years of backtesting according to embodiments of the present disclosure.

FIG. 3 is a graph of corn backtesting results by month for 2003-2018 according to embodiments of the present disclosure.

FIG. 4 is a graph of soy backtesting results by month for 2003-2018 according to embodiments of the present disclosure.

FIG. 5 is a map showing county-level mean absolute percent error from backtesting for corn model on October 12th according to embodiments of the present disclosure.

FIG. 6 contains partial dependence plots for our major states corn model on October 12th according to embodiments of the present disclosure.

FIG. 7 is a plot of Variable importance throughout time for a major state corn model according to embodiments of the present disclosure.

FIG. 8 is a graph of an exemplary vegetation index over a year according to embodiments of the present disclosure.

FIG. 9 is graph of an example EVI2 curve for a MODIS pixel according to embodiments of the present disclosure.

FIG. 10 is graph of a linear regression applied to multiple geographic regions according to embodiments of the present disclosure.

FIG. 11 is a graph of weights assigned to different collections of predictors over the course of a growing season according to embodiments of the present disclosure.

FIG. 12 contains plots for key model fit metrics according to embodiments of the present disclosure.

FIGS. 13-16 are graphs of monthly backtesting results according to embodiments of the present disclosure.

FIGS. 17-20 are plots of standardized coefficients according to embodiments of the present disclosure.

FIG. 21 is a graph of exemplary yield distributions according to embodiments of the present disclosure.

FIG. 22 shows exemplary HLS and MODIS time series according to embodiments of the present disclosure.

FIG. 23 shows exemplary ndwi data for a one year period according to embodiments of the present disclosure.

FIG. 24 shows exemplary yield data according to embodiments of the present disclosure.

FIG. 25 is a chart of feature importance according to embodiments of the present disclosure.

FIG. 26 illustrates a method of predicting crop yield of a geographic region according to embodiments of the present disclosure.

FIG. 27 depicts a computing node according to an embodiment of the present disclosure.

### DETAILED DESCRIPTION

The present disclosure provides models to forecast crop yields. Exemplary crops include cereals such as wheat, rice, barley, buckwheat, rye, millet, oats, corn, sorghum, triticale, spelt, or sugar cane, and dicots such as cotton, canola, sunflower, tomato, lettuce, peppers, cucumber, endive, melon, potato, or soy. Forecasts from these models may be shared through various channels including web applications. Various models according to embodiments of the present disclosure employ machine learning methods to extract signals from satellite imagery, weather data and on-the-ground observations of crop conditions and use them to predict end-of-season yields. Validation of these models through a “leave-one-year-out” backtesting approach demonstrates their ability to translate these signals into accurate forecasts of the productivity of the crops of interest. Results from this backtesting approach as applied to exemplary 2019 data, discussed further below, demonstrate that corn models according to the present disclosure has an end-of-season RMSE of 3.0 bu/ac while soy models according to the present disclosure have end-of-season RMSE of 1.6 bu/ac. As set out below, in some embodiments, models are designed to be most accurate at generating end-of-season national yield numbers; however, such embodiments provide accurate forecasts throughout the season and for sub-geographies, including at state and county levels. In some embodiments, models are provided that prioritize in-season forecasts, or to provide field-level granularity.

Compared to alternative approaches, models described herein provide greater transparency in the form of clear forecast drivers, facilitating better understanding of in-season movements, and provide more accurate in-season representations of uncertainty in estimates.

The backtesting results described herein demonstrate the exceptional quality of the models described. In particular, average end of season error rates for exemplary corn and soy models according to the present disclosure are 1.5% and 2.8%, respectively. By mid-August, average error rates observed in this backtesting are 2.9% and 3.9%, for corn and soy, respectively. More generally, average end of season error rates for corn and soy models according to the present disclosure provide low error rates that provide commercially useful insight into these crops. Various examples provided herein exhibit national scale errors rates of 1-4% and county scale error rates of 10% or less.

The present disclosure shares details on approaches to forecasting corn and soy yields for the 2019 US growing season. However, it will be appreciated that the present disclosure is applicable to forecasting other crops over other growing periods.

Approaches to crop yield forecasting include survey-based, weather and climate-based, and bio-physical models. Satellite imagery offers a way to augment these existing approaches to yield forecasting. Incorporating satellite imagery into crop yield forecasting allows for high-cadence monitoring of crop health conditions over the entire growing season, for the entire area of interest. A short history of satellite data and insufficient computing power delayed deployment of this approach. The decreasing cost of cloud computing resources, expanded longitudinal record from a variety of satellite sensors, and the development of new machine learning methods enables maturation of this approach.

In various embodiments, approaches to crop yield forecasting rely on remotely sensed imagery as an input. These data provide a useful tool for monitoring the health and productivity of crops over a large geographic extent in near-real time. In various embodiments, machine learning methods are applied, which are described further below. In various embodiments, forecasting is provided for field, county, state and national scale yields.

Average field size varies significantly by crop and region. For example, the average corn farm in the U.S. is approximately 333 acres, while the average soybean farm in Brazil is approximately 3,086 acres (slightly less than 5 square miles). The smallest U.S. county is approximately 12 square miles, with most being many multiples larger. For the purposes of the present discussion, field scale generally refers to agricultural regions of 10 square miles or less. More generally, it will be appreciated that the techniques described herein for field scale analysis, while adapted for smaller regions, may be applied to larger regions. Techniques described herein for larger regions may be applied to smaller regions as satellite pixel size shrinks. That is, while 500 m spatial resolution MODIS may limit the use of certain techniques at the field scale, a future reduction in pixel size would enable the use of those techniques at smaller scale.

In the US, crop yield data are reported by the USDA across a variety of scales including county, agricultural district, state and national. Although yield information is collected and reported across these different spatial scales, the most frequently referenced quantities are the national yields. The present disclosure allows generation of an accurate estimate of national level yields, while simultaneously generating yield forecasts across other scales of interest as well. To achieve these objectives, various embodiments employ a two-step approach to yield forecasting:
1. Construct models to predict yields by county using machine learning methods; and
2. Aggregate the county scale yield predictions using acreage weightings and build a linear model that incorporates the county-level predictions to obtain state and national scale yield predictions.

Through step 1 above, forecasts are built for all major producing counties in the US, via two separate models: a Major States model and an Other States model. Separate models are trained for predicting corn and soy yields. The Major States models are trained using county data from the top 9 producing states for corn and 8 of the top 9 states for soybeans. The Other States models are built using counties from all other states for each crop. The models are constructed in this fashion because the subsequent forecasts are more accurate than trying to combine all states into a single model. National scale yield forecasts are built by scaling up county forecasts coming only from the Major States county-scale model. Table 1 shows which states are employed for the Major States and Other States models for both corn and soy.

In particular, Table 1 shows states employed in the Major States models and their average production from 2003 to 2018 in millions of bushels (Mbu).

TABLE 1

| Corn | | Soy | |
|---|---|---|---|
| | Mean | | Mean |
| | Production | | Production |
| State | (Mbu) | State | (Mbu) |
| Iowa | 2,281 | Iowa | 488 |
| Illinois | 2,016 | Illinois | 485 |
| Nebraska | 1,482 | Minnesota | 309 |
| Minnesota | 1,254 | Indiana | 270 |
| Indiana | 899 | Nebraska | 258 |
| South | 629 | Ohio | 221 |
| Dakota | | | |
| Ohio | 518 | Missouri | 210 |
| Kansas | 513 | North | 151 |
| | | Dakota | |
| Wisconsin | 455 | | |

The county scale models are separated into the “major” and “other” states principally because of data quality concerns. County yield records from the USDA used as ground truth in these models are survey-based, an approach that may introduce measurement errors. Yield forecasts appear to be less reliable and stable in lower producing regions (“other” states), which may reflect larger uncertainties in the USDA survey data in these areas. Including county yield observations from these “other” states lowers the accuracy of the model. Additionally, crop condition data outside major productivity regions are also less consistent and reliable.

Yield forecast models according to the present disclosure employ a variety of data sources. They rely on signals from remotely sensed satellite imagery, while also employing features drawn from weather data and crop condition surveys conducted during the growing season. A discussion of data sources, both considered and employed in forecasting, follows.

In various embodiments, historical crop yield data are obtained from the USDA's National Agricultural Statistics Service (NASS). These data serve as a response variable (the “truth” or “right answer” that models are trained to predict). The yield records are survey-based and available at the county, agricultural district, state, and national levels. These data can be traced back to the mid-19th century. However, for present purposes, we focus on data from 2003 to present, as these years match our historical satellite data record.

In various embodiments, daily satellite imagery is obtained from a variety of sources. Various satellite-borne sensors and imagery platforms can be employed to monitor the health of crops over wide geographic areas and through time (e.g., MODIS, Landsat, Sentinel 1 and 2, Planet, HLS, etc.). In various embodiments, MODIS imagery is used for modeling.

MODIS has certain advantages in this context—Longitudinal coverage: MODIS data are available back to 2001 (although we only employ data from 2003 forward in our modeling to ensure the highest quality data, provided by coverage from both the Aqua and Terra satellites). Daily revisit rate: MODIS provides imagery at a much higher temporal resolution (frequency) than most other satellite-borne sensors. Employing MODIS data provides us daily views of crop growing regions, critical for compensating for lost imagery due to clouds and atmospheric interference. Product maturity: The MODIS sensor has a strong reputation among academic researchers from a variety of disciplines. The high quality of MODIS' radiometry and calibration is well documented and there are a multitude of studies illustrating its utility in monitoring crop conditions. Spatial resolution: The majority of the MODIS spectral bands used for monitoring vegetation have a spatial resolution of 500 meters. Although relatively coarse in the context of many other modern sensors (e.g., Sentinel 2, Landsat, etc.) this pixel size provides sufficient spatial granularity to accurately evaluate crop health at the scales of analysis described herein (county and above), while still providing a timely revisit rate.

In various embodiments, MODIS data is sourced from a number of locations, for example, the Nadir Bidirectional Reflectance (Distribution Function (BRDF)-Adjusted Reflectance (NBAR) product (i.e. MCD43A4) available from the NASA Land Processes Distributed Active Archive Center (LP DAAC) Distribution Server hosted at the USGS Earth Resources Observation and Science (EROS) Center. If the fully processed NBAR data are unavailable due to occasional lags in processing, any missing data may be backfilled using a near real-time version of that product (e.g., MCD43A4N) available from NASA's EarthData portal.

In various embodiments, in addition to MODIS spectral data, MODIS-derived imagery products, such as the Land Cover Dynamics product (MCD12Q2) are used to help determine crop phenology stages and identify changes in the growing season through time.

In various embodiments, weekly crop condition reports are obtained from the USDA NASS. These data summarize the crop condition at the scale of states into five categories (very poor, poor, fair, good, excellent) and are available across the full temporal extent of other training data sources.

In various embodiments, daily weather observations data are obtained from University of Idaho's gridMET product. From this dataset, products are used directly or derivative products are calculated pertaining to: Max/min relative humidity; Max/min/average air temperature; Accumulated precipitation over the growing season; Land surface temperature; Specific humidity; Downward radiation; Growing degree days; Extreme hot/cold days; Vapor pressure deficit. It will be appreciated that a variety of additional weather sources are suitable for use as described herein, which may be selected on the basis of data quality and geographic coverage.

In some such embodiments, the USDA's Cropland Data Layer (CDL) is used to help exclude non-crop pixels from the analysis, so that the signals are more representative of the health and condition of the crop of interest. The resulting layer is an example of a crop mask.

With regard to the CDL, special handling may be used to generate a crop mask while accommodating the limitations of the CDL data. For 2008-2018, the CDL data may be used unmodified. For years prior to 2008, an alternating rotation of crops is assumed in order to fill gaps in coverage. Thus 2008's map is used for 2006 and 2004 and 2009's map is used for 2007, 2005 and 2003. This serves to fill gaps in the CDL coverage. For this example, the 2017 CDL is used to build the crop mask for 2019.

More generally, a crop mask may also be built from agency or commercially reported crop data layer such as CDL, satellite-based crop type determination methods, ground observations such as survey data or data collected by farm equipment, or combinations thereof. Different crop masks may be used during a single season. For example, a One type of crop mask (e.g. CDL) may be used at the beginning of the season and may be replaced in-season with a mask built from a different data source (e.g. using satellite-based crop type determination methods).

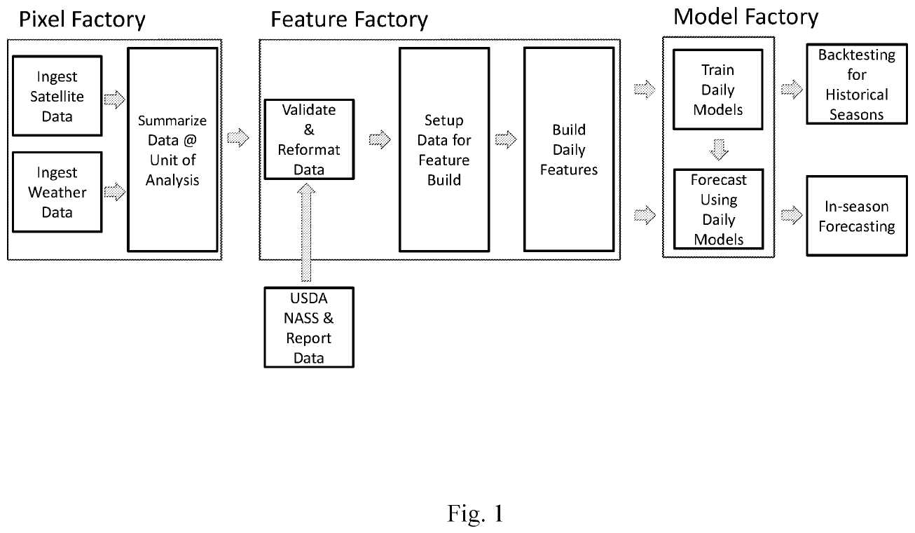

With reference now to FIG. 1, an exemplary data processing pipeline is illustrated according to embodiments of the present disclosure. FIG. 1 summarizes the data processing workflow, from ingestion of satellite imagery through to model training and forecasting. The illustrated steps in this process are described further below.

Pixel Factory Processing

To create tabular features from satellite imagery and weather data that join to county-level crop yields in a one-to-one manner, the raster weather and imagery data are summarized at the unit of analysis employed by the models. In this case, at the county scale. The “Pixel Factory” code carries out this computationally-intensive process, referred to as zonal summarization, in an efficient manner. This process yields a time series data frame that provides summarized weather and satellite data observations each day for each county of interest.

In various embodiments, zonal summarization is performed at the county level. However, it will be appreciated that alternative geographic regions may be summarized in this manner, with attendant tradeoffs in terms of computation time and complexity.

In various embodiments, county-level summaries include various daily metrics. In some embodiments, the metrics each represent mean values across the zones (e.g., counties). In various embodiments, the data summarized include: MODIS NBAR (surface reflectance data)—Blue, green, red, NIR, SWIR1, SWIR2, SWIR3, NDVI, EVI2, NDWI, CHI, TC-B, TC-G, TC-W; MODIS LST (Land surface temperature)—LST-day and LST-night; and/or University of Idaho GRIDMET product—Minimum and maximum daily temperatures, precipitation, minimum and maximum daily relative humidity, specific humidity, down-welling surface radiation, GDD, PDSI.

In various embodiments, summaries are generated using a map/reduce workflow. Each product/date/tile is processed within individual tasks in the map step at the same time using a large pool of AWS EC2 instances. During this first step, data for that product/date/tile are read in and binned statistics are generated in parallel. Then there are spatial and temporal reduce steps that create the final datacube in CSV format.

### Defining Phenology Periods

To compress the daily data into a smaller and more meaningful set of predictors, they are further summarized across key phenology periods in the life cycle of the crops. To help establish the dates corresponding to these time periods, the MODIS Land Cover Dynamics product is employed to define the start, end, and peak of each crops vegetative life cycle in each county for each year of interest in the training data. These highly localized dates, which are derived from the MCD12Q2 product, are then used to help build distinct phenological periods over which the satellite and weather data are summarized over the course of the season (e.g., peak photosynthetic activity to dormancy, emergence to maturity, etc.).

The period start and end times vary by county and by crop, but the period labels are universally applied. County averages are employed across time to keep the windows consistent across years. The phenology periods themselves were defined via a mathematical optimization process that breaks up the growing season for each crop into segments such that summaries of the predictors across those segments offer the maximum correlation with end of season yields. It will be appreciated that a variety of region scales may be used, from field scale to national scale. It will also be appreciated that phenology periods are defined within a region of interest, but may be applied to smaller scale regions.

In an exemplary embodiment, the growing season is broken up (at the county level) into different percentage cutoffs (using the same cutoffs across all counties in each iteration while exploring the solution space). These cutoffs divide the season (defined as the period of time between the greenup and dormancy) into 4 segments. The features are summarized per period (including, e.g., mean, sum, etc.) and the features built from the varying percentage cutoffs are correlated with yields for the county. The percentage cutoffs that resulted in the overall highest correlations were the percentage cutoffs that were employed.

In various embodiments, MODIS Land Cover Dynamics is used to define the season, while weather and satellite crop health features (and yield) are used for correlation.

In various embodiments, the growing season is divided into 4 phenology periods for both corn and soy. In exemplary embodiments, the phenology periods define bins in time from green-up to dormancy, with the following fractional bin edges: corn=[0.0, 0.4, 0.7, 0.9, 1.0] and soy=[0.0, 0.4, 0.6, 0.8, 1.0].

USDA Data Processing

The USDA's NASS data provides yield, acreage and production information at the county level for most counties growing corn and soy. However, many of those counties are only minor producers. To focus model training and forecasting on counties that matter most, any observations where the county did not harvest more than 5,000 acres of the crop of interest are filtered out.

Feature Construction

With the daily satellite and weather data matched to phenology periods and the subset of counties of interest identified, the process of creating features to be employed in the predictive model is begun. This involves aggregating the daily data within the phenology periods and summarizing the distribution of observations within the phenology periods via, e.g., mean, median, maximum and sum statistics, depending on the variable of interest. In various embodiments, the aggregated data are labeled with a phenology period (e.g., p1, p2, p3) as shown in Table 2.

In creating these features, summarized across phenology periods, care needs to be taken when calculating them to account for the parts of the season that remain unseen at any given point in time. For example, at the beginning of the season, there are no observations of any part of the final phenology period (e.g., senescence of the plants) for the current season. As such, those values must be imputed based on data from previous seasons. This gives an indication of what normal conditions during this period for the current year may look like based on what is expected from previous years. As we progress into that phenology period, the imputed data are updated with actual observations. This is a challenging problem, especially in the context of backtesting: it is necessary to ensure that the current year and prior years are treated properly to ensure the backtesting process is an accurate representation of how the model will perform out of sample.

In some embodiments, for coarse spatial and temporal resolution data sources that don't lend themselves to summarization across phenology periods, such as the crop condition reports, the most recent and geographically relevant observation is taken.

A final set of features considered by the model is the maximum value observed up until the current point in the growing season, across a selection of vegetation indices. For these features, no imputation (as discussed above) is necessary, the maximum value for the variable to date is employed as the predictor. In some embodiments, smoothing is performed across the vegetation index time series to date to remove any spurious peaks (a problem especially in the early season). In some embodiments, smoothing is performed using locally estimated scatterplot smoothing (LOESS), although it will be appreciated that a variety of smoothing methods are suitable for use according to the present disclosure.

In various embodiments vegetative indices include Normalized Difference Water Index (NDWI), TellusLabs' Crop Health Index (TL CHI) and NDSW2 ((NIR−SW2)/(NIR+SW2)).

More generally, it will be appreciated that the present disclosure is applicable to a variety of surface features of a geographic region. Surface features may include bands, vegetation indices, or environmental properties or plant health derived from one or more a bands and/or vegetation indices.

Feature Selection

By the end of the feature construction stage, there are approximately 300 features available for modeling. However, in various embodiments, they are not all provided into the machine learning algorithms. This reduction is motivated by two factors: 1) many of them are extracted from the same remote sensing bands, and as such are highly correlated (including similar features together will hurt model interpretability); 2) features derived from the satellite imagery can be treated as an indirect measurement of crop conditions, and they already reflect a lot of weather and environment conditions. Thus, to gain better predictive power and maintain better interpretability of the model, various embodiments employ extensive feature selection.

The feature selection process combines manual selection of features based on domain expertise and automatic selection by machine learning algorithms to achieve best results. In an exemplary embodiment, automatic selection is performed by constructing a smaller feature set based on domain knowledge, and then using the XGBoost variable importance to further select features. In the end, the feature set is reduced dramatically, to under 20 features after this step. Two slightly different feature sets, one for early season and one for late season models, provide additional accuracy. Features employed in various exemplary embodiment are listed in Table 2.

Table 2 lists variables employed in various predictive models and their sources.

TABLE 2

| Variable | Definition | Source |
|---|---|---|
| PCT.GOOD | Percent of crop in each state | USDA Crop |
| | rated in the USDA's good | Progress and |
| | category | Condition |
| PCT.POOR | Percent of crop in each state | Report |
| | rated in the USDA's poor | |
| | category | |
| irrigation_pct | Percent of county that is | USDA |
| | irrigated | NASS |
| met_avgt_mean_p1/2/3 | Average temperature during | University of |
| | phenology period 1/2/3 | Idaho gridMET |
| met_mint_mean_p1/2/3 | Minimum temperature during | |
| | phenology period 1/2/3 | |
| met_pmm_sum_p1/2/3 | Total precipitation during | |
| | phenology period 1/2/3 | |
| mod_ndwi_mean_p2/3 | Average NDWI during | MODIS |
| | phenology period 2/3 | MCD43A4 & |
| mod_tlchi_mean_p1/2/3 | Average Indigo CHI during | MCD43A4N |
| | phenology period 1/2/3 | Products |
| mod_nir_mean_p2 | Average NIR during | |
| | phenology period 1/2/3 | |
| ndsw2.sm | Maximum Indigo water index | |
| | up to the prediction date | |
| phen_gsl | Growing season length | MODIS |
| year | The crop year | MCD12Q2 |

Modeling

As noted above, various embodiments use two stages in modeling: 1) county scale models, one that includes major producing states and a second that includes all other states; and 2) linear models that aggregate county forecasts into state and national scale forecasts. Each of these stages is described in greater technical detail below.

County Scale Forecasts

Separate models are constructed for each date that we generate a yield forecast. That is, the models are updated as new data become available (e.g., from day to day). Thus, in some embodiments a daily, independent model approach is adopted. In various embodiments, the set of predictors remains mostly stable during the growing season to allow better interpretability. An alternative approach would be allow the selection of predictors to vary from day-to-day based on a machine learning feature selection algorithm. Independent daily models capture the varying importance and relevance of features as the season progresses. Maintaining the same sets of predictors allows a better understanding of what is driving in-season changes in predicted yields. Exploring the feature importance weights assigned by the models over the course of the season (shown below) illustrates that the changes in importance evolve smoothly over time and align nicely with agronomic principles.

In various embodiments, the selected features are provided to a learning system. Based on the input features, the learning system generates one or more outputs. In some embodiments, the output of the learning system is a feature vector.

In some embodiments, the learning system comprises a support vector machines (SVM). In other embodiments, the learning system comprises an artificial neural network. In some embodiments, the learning system is pre-trained using training data. In some embodiments training data is retrospective data. In some embodiments, the retrospective data is stored in a data store. In some embodiments, the learning system may be additionally trained through manual curation of previously generated outputs.

In some embodiments, the learning system, is a trained classifier. In some embodiments, the trained classifier is a random decision forest. However, it will be appreciated that a variety of other classifiers are suitable for use according to the present disclosure, including linear classifiers, support vector machines (SVM), or neural networks such as recurrent neural networks (RNN).

Suitable artificial neural networks include but are not limited to a feedforward neural network, a radial basis function network, a self-organizing map, learning vector quantization, a recurrent neural network, a Hopfield network, a Boltzmann machine, an echo state network, long short term memory, a bi-directional recurrent neural network, a hierarchical recurrent neural network, a stochastic neural network, a modular neural network, an associative neural network, a deep neural network, a deep belief network, a convolutional neural networks, a convolutional deep belief network, a large memory storage and retrieval neural network, a deep Boltzmann machine, a deep stacking network, a tensor deep stacking network, a spike and slab restricted Boltzmann machine, a compound hierarchical-deep model, a deep coding network, a multilayer kernel machine, or a deep Q-network.

In various embodiments, the learning system employs Extreme Gradient Boosting (XGBoost) for predicting county scale yields. This algorithm is employed in various embodiments because: 1) its tree-based structure can handle the non-linear relationships between predictors and yield outcomes and 2) it automatically captures interactions among features well, so they do not need to be pre-computed. Additionally, XGBoost is computationally efficient relative to similar machine learning methods.

In various embodiments, a separate model is not trained to capture long-term trends in yields, although this is one alternative. Instead, the year associated with observed and predicted yields is included in the XGBoost county yield model directly as a predictive feature. This provides a more elegant approach. Additionally, given that trend is modeled using the XGBoost algorithm directly, the algorithm captures non-stationarity in the evolution of yields over time (this is confirmed in the results discussed below). However, adding the year feature directly in the model leads to the possibility of overfitting. In various embodiments, this risk is overcome by restricting the interaction of the year feature.

National & State Forecasts

For larger geographical regions, the NASS yield records are derived by aggregating the corresponding county records. This can be shown from the yield definition in Equation 1.

$$Yield = \frac{Total Production}{Total harvest acres} = \frac{{\sum }_{i ∈ S} {Yield}_{i} \times {acres}_{i}}{{\sum }_{i ∈ S} {acres}_{i}} = {\sum }_{i ∈ S} {Yield}_{i} \times \frac{{acres}_{i}}{\sum {acres}_{i}} \qquad Equation 1$$

In Equation 1, S is the set of counties included in the region of interest. The formula illustrates that the regional (national or state level) yield can be derived from acreage weighted average of county level yields directly.

Given this fact, one estimator of the regional forecast would be to use Equation 1 with the county level predictions. However, this approach poses several issues. First, harvest acreage data is not available until the end of the season. Based on historical records, the acreage weights are relatively stable over the years and using average weights from the last 3 years achieve good results. Because of the aforementioned data quality concerns, not all the counties are used to train the county level model. Thus, the weighted average might be biased based on the sample selected to train the model. To correct this possible bias, a linear model is built on top of the county aggregations to obtain the final regional predictions as in Equation 2.

$$Yield = a + b {\sum }_{i} {\hat{Yield}}_{i} \times {\hat{w}}_{i} + ε \qquad Equation 2$$

In Equation 2, ŵᵢ is the estimated area weight for county i. To account for different regional variations, separate linear models are constructed for national level forecasts, major states, and other states forecasts.

Model Evaluation

In an exemplary experiment, to evaluate model performance, we adopted a leave-one-year-out cross validation (backtesting) strategy. This allows us to select a model structure that provides accurate forecasts, but also minimizes over-fitting. This cross-validation strategy also provides the best method of estimating out-of-sample uncertainty estimates for the 2019 growing season. In this backtesting strategy, we estimate models for each year in our historical record by training on all other years and then deploy the constructed model on the held out year. We repeat this process across all years in the record and then examine our results. For the current year's models, we use the same features, model type, etc. and then re-train new models using all available historical data. Performance for the current year is expected to approximate what we observe in our backtesting results.

To evaluate our backtesting results, we consider the following error metrics in our performance assessment across all scales of models:
Mean Absolute Error (MAE): robust to outliers, however not great for evaluating the national level performance, as there are only 16 data points and each year matters.
Root Mean Squared Error (RMSE): more influenced by extreme outliers, by definition will always be greater than the MAE.
Mean Absolute Percentage Error (MAPE): can be used to compare performance across crops.
Mean Prediction Interval Width (MPIW): provides the width of prediction intervals to quantify the prediction uncertainty.

Results

To quantify the predictive capacity of the models including county, state and national-scale metrics, we focus on the average error in the national-scale predictions throughout the growing season, and compare these errors with in-season predictions from the USDA. Also, we explore the spatial distribution of county scale errors. Lastly, we provide visualizations to aid in model interpretability.

National Yield Predictions

As discussed above, exemplary models are trained using a leave-one-year-out cross validation strategy which is used to estimate how well the model will perform on unseen data during the current (2019) growing season. Corn and soy models were trained on 16 years of historical weather and satellite data, with USDA NASS data providing ground truth for crop yields. Predictions for each year are made by fitting models based on all data excluding the held-out year, as described in the cross validation strategy above. In October, average absolute percent error is 1.5% for corn predictions and 2.8% for soy.

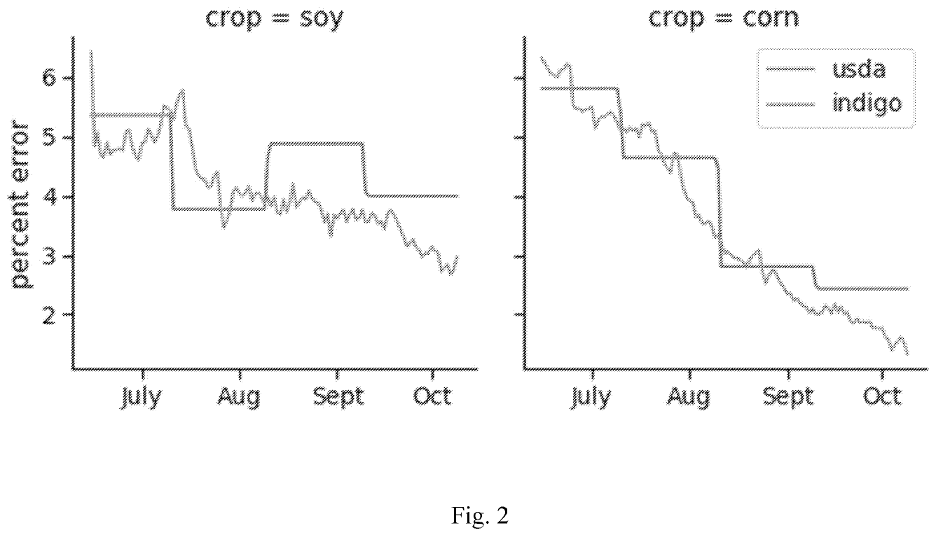

In FIG. 2, we plot the mean absolute percent error of the weekly models compared to the error in monthly USDA in-season predictions of national yield. Both estimates, from the USDA survey and from the models, generally perform better as the season progresses and higher quality data become available; however, the models consistently outperform USDA estimates, especially in the latter half of the forecasting period (September & October).

Errors from an exemplary model as described herein (Indigo) and USDA models are aggregated by month and presented in Table 3 for corn and soy. Soy models consistently beat USDA estimates by nearly a full percentage point, while corn models offer a half percentage point advantage throughout the season.

Table 3 gives mean absolute percent error by month averaged across all years of backtesting (2003-2018).

TABLE 3

| | Soy | | Corn | |
|---|---|---|---|---|
| Month | Indigo | USDA | Indigo | USDA |
| Jun. | 4.91 | 5.35 | 5.82 | 5.81 |
| Jul. | 4.65 | 4.55 | 4.88 | 4.93 |
| Aug. | 3.86 | 4.79 | 2.99 | 3.24 |
| Sep. | 3.44 | 4.20 | 1.99 | 2.52 |
| Oct. | 2.83 | 4.00 | 1.50 | 2.43 |

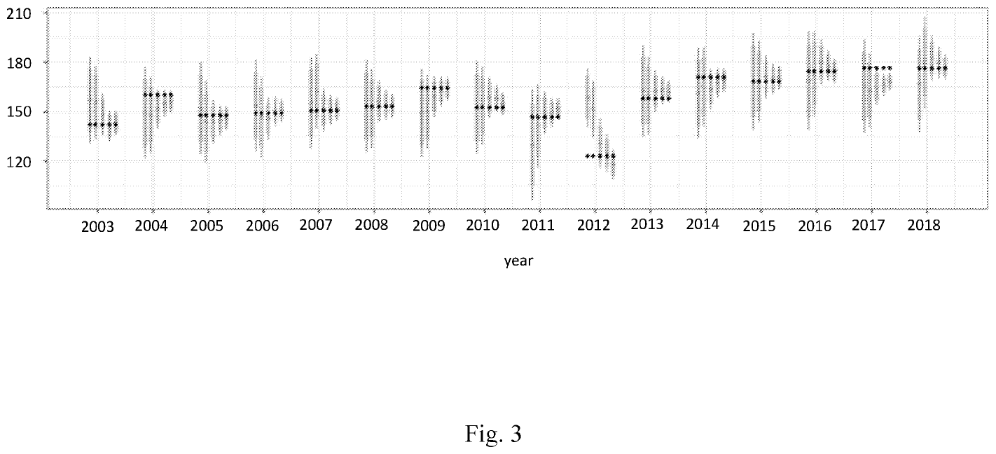

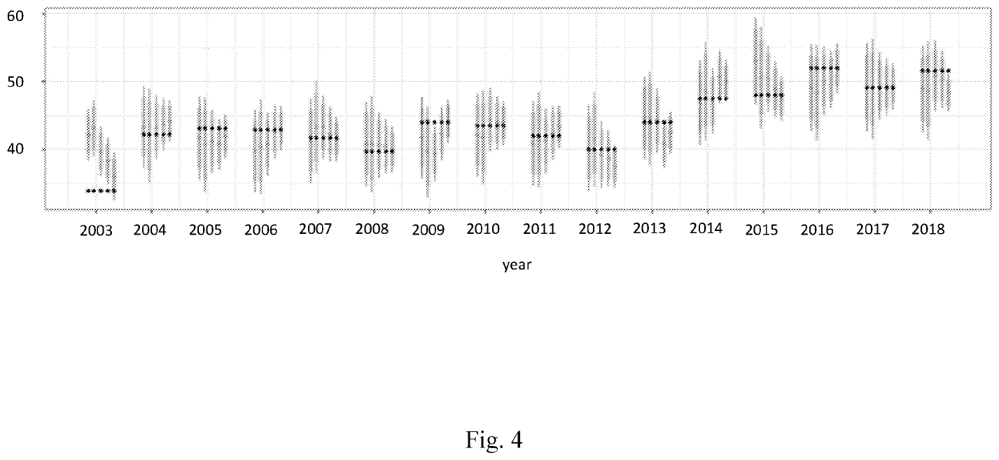

Another way of looking at this is to disaggregate performance across years. In FIGS. 3 and 4, the black dots represent the final USDA yield for each year, while the colored box plots show the estimate (center of box plot) and associated prediction intervals (95% and 85%) for model forecasts for each month in the growing season. The prediction intervals shrink over time and include the final USDA yield in all but 1 year for each crop. For each year, the boxplots correspond to the months of the growing season in order—June, July, August, September, and October.

County Yield Predictions

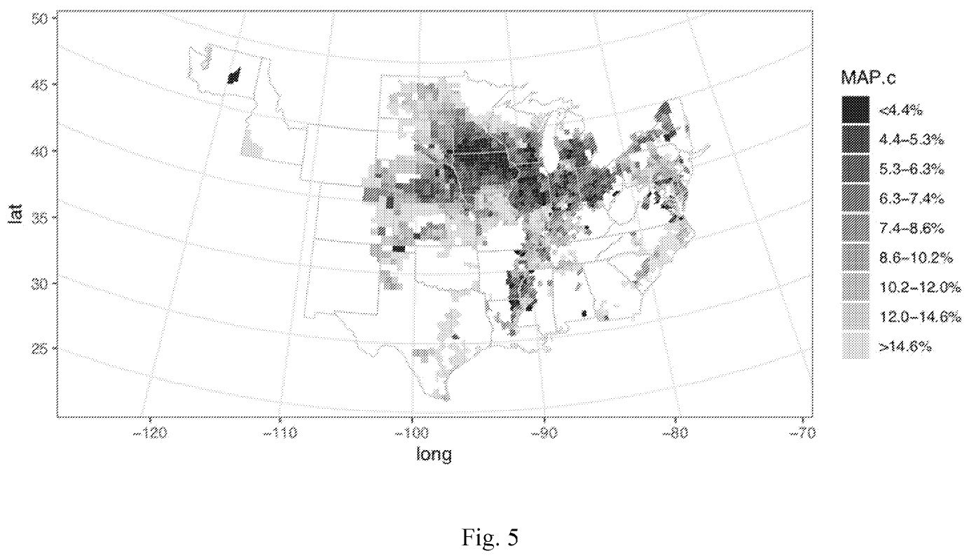

In addition to characterizing the quality of yield predictions as a function of time during the growing season at national scale, it is also valuable to understand how the quality of predictions vary geographically within the United States. FIG. 5 shows a map of county-level mean absolute percent error for the corn model trained for October 12th. The map reveals a general pattern of high accuracy in the Corn Belt region of the Midwest including Iowa, Indiana, Illinois, eastern Nebraska, and southern Minnesota. These are regions of generally high yield, which, for the most part, (eastern Nebraska aside) do not employ irrigation. Model accuracy suffers in higher variance regions where yields are less consistent from year-to-year and where practices such as irrigation vary from field to field. In particular, Kansas, Missouri, and the Dakotas in addition to southern states and states along the Eastern seaboard are typically harder to predict.

Model Interpretability

A trade-off in machine learning is predictive capacity versus model interpretability. Increasing the number of fitting coefficients and feature interactions in a machine learning model may improve accuracy, but can also hamper one's ability to interpret how differences in input features affect the final predictions. In approach described herein, interpretable models with high performance are maintained by using a limited number of carefully curated features and by creating visualizations that reveal how input features drive predictions.

Partial Dependence Plots

A partial dependence plot is a visualization tool to understand how different features (inputs) affect the outcome (prediction) of a machine learning model. The y-axis of a partial dependence plot corresponds to the outcome of the machine learning model, where a higher value indicates a positive effect on the outcome variable and a lower value corresponds to a negative outcome.

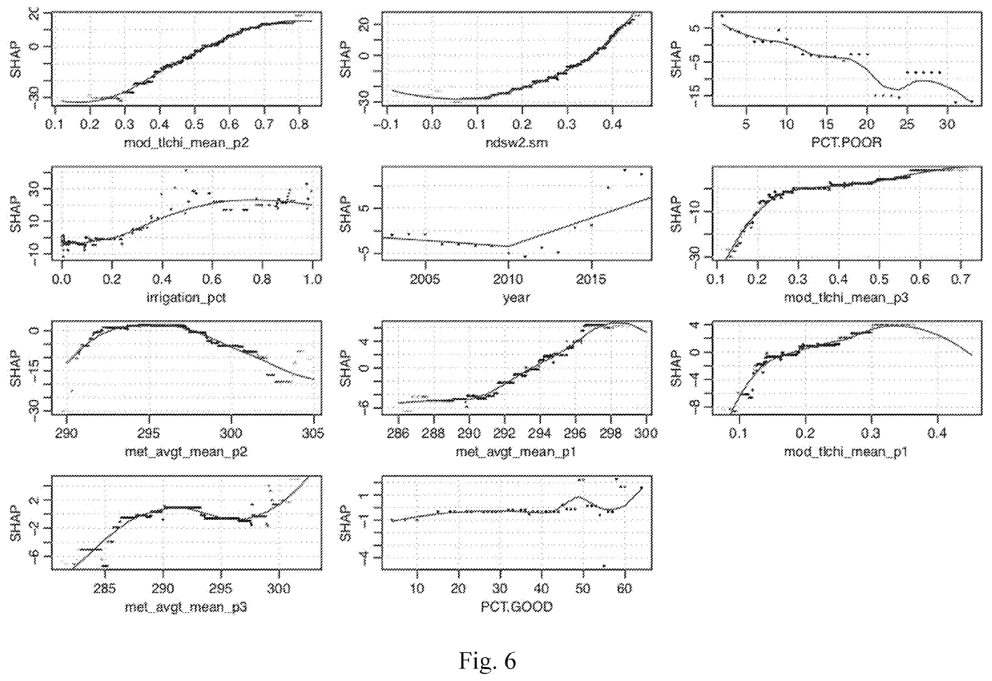

In the case of yield models described herein, partial dependence plots were built for each date's models across each crop. To illustrate, an example is presented in FIG. 6 for the corn model trained for October 12th. A near-linear relationship is observed between the maximum vegetation predictor (ndsw2.sm) and the yield outcome. Other properties that have a positively correlated relationship with yield include PCT.GOOD, irrigation_pct, mod tichi_mean_p1/2/3. PCT.POOR shows a negative correlation with yield, as expected. Average temperature shows more complex relationships with yield during the different phenology periods. Relatively high or low temperatures negatively affect yields while moderate temperatures tend to increase yield estimates. Lastly, the partial dependence on year demonstrates that, in recent years, yields have increased at a higher rate than from 2003-2010.

Feature Importance

Various yield models described herein are based on tree-based machine learning algorithms that make use of ensembles of decision trees. At each node in a tree, data are split based on empirically estimated decision rules (e.g., is the value for ndsw2.sm greater than 0.5?) and the resulting sub-groups are assigned a yield value based on yields of training observations assigned to each final subset of data. The performance gain of the model by including a certain decision is associated with that feature's (e.g., ndsw2.sm from above) importance. Aggregating the performance gains attributed to each feature (vegetation indices, precipitation, crop condition, etc.) allows us to understand which features drive the model predictions.

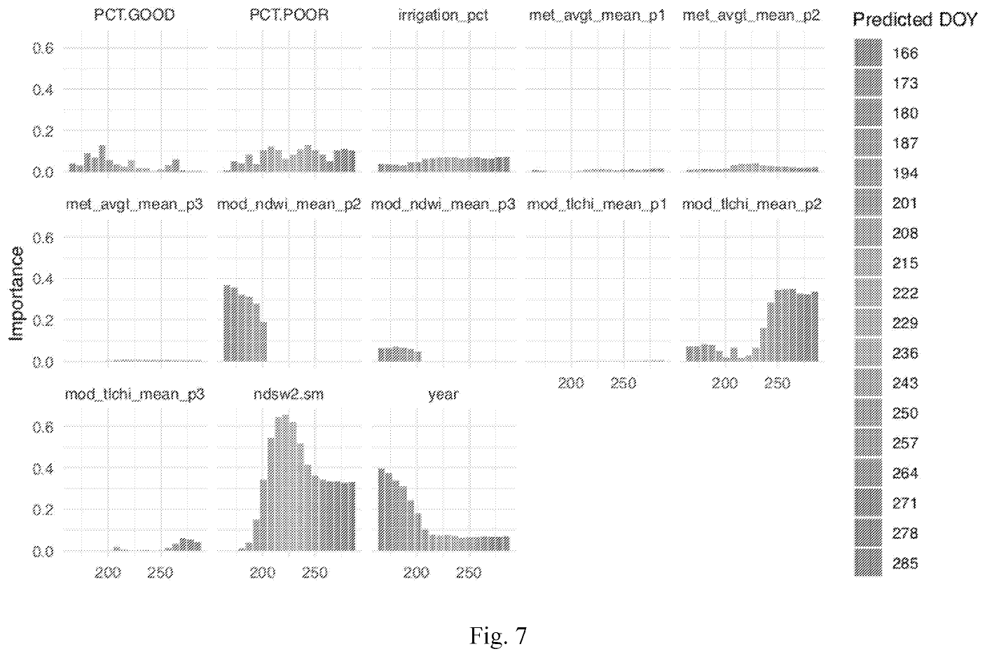

In FIG. 7, variable importance is shown throughout the year for the major state corn model. While the same features were used to train the model each day, the relative importance of each feature changes with time. For example, in the early season, from the end of June to the beginning of July, the most important features are the year, and the historical average of the NDWI during the second phenology period (mod_ndwi_mean_p2). This indicates that early in the season, the long-term trend and historical performance of each county (which is incorporated into the historical NDWI value) play the biggest role in forecasting the end-of-season county yield, since new signals of crop health are still weak. As the season progresses, remotely sensed signals become more informative. Accordingly, the variables proxying for yearly trend becomes less important, while the vegetation indices mod tichi_mean_p2 and ndsw2.sm (recall, max vegetation health across the season) emerge as the most important features. Throughout the season, information from the crop condition reports and historical irrigation practices also play a critical role in forecasting end-of-season yields.

South America Corn and Soy Yield Forecasting

In the following example, models are provided to forecast corn and soy yields in Brazil and Argentina for the 2019/20 growing season. As in other examples, satellite data is used as the primary predictors. Features are constructed from the imagery based on time series data from individual pixels rather than collections of pixels.

Results from backtesting the corn and soy yield model using a leave-one-year-out methodology are shown in Table 4, with MAE and RMSE values given in kilograms per hectare.

TABLE 4

| | | MAE | MAPE | R2 | RMSE |
|---|---|---|---|---|---|
| Brazil | Soy | 73.92 | 2.71% | 0.93 | 87.36 |
| | Corn (Full) | 124.3 | 2.97% | 0.97 | 145.7 |
| Argentina | Soy | 104.1 | 3.75% | 0.87 | 133.7 |
| | Corn | 218.5 | 3.28% | 0.87 | 273.2 |

While the United States remains the top producer of corn and soybeans globally, Brazil and Argentina are key grain and oilseed producers accounting for 13.5% and 48.1% of the corn and soy supply, respectively. Table 5 shows global corn and soy production data pulled from the Jan. 10, 2020 USDA FAS report. While the U.S. and China dominate the global corn market, Brazil and Argentina are collectively responsible for more than 48% of global soy production and have a substantial impact on the market. Production values are given in million metric tons (MMT).

TABLE 5

| | Corn | | Soy | |
|---|---|---|---|---|
| | Production | % of | Production | % of |
| | (MMT) | Total | (MMT) | Total |
| US | 364.3 | 32.5% | 120.5 | 33.6% |
| Brazil | 101.0 | 9.0% | 117.0 | 32.7% |
| Argentina | 51.0 | 4.5% | 55.3 | 15.4% |
| China | 257.3 | 22.9% | 16.0 | 4.5% |

There are unique challenges associated with forecasting crop yield and production in South America, that are addressed by the approaches set out herein.

Data quality poses a challenge. In general South American crop data are harder to find and of less consistent quality than data covering the US.

Complex cropping systems pose a challenge. As a large share of Brazil's agricultural areas are located in tropical or semi-tropical regions, the country has a very long growing season. In some areas, crops can be planted almost all year around. Brazilian farmers are increasingly opting to plant soy followed by a second corn crop (known as safrinha) rather than planting a full season corn crop.

Rapid technological development poses a challenge. The region's agriculture industry is rapidly developing. Yield and area planted can change dramatically from year to year. Production increased sharply in the early 2000s due to technological improvements and the increasing agricultural footprint.

Yield forecasting depends on a source of historical yield data. In South America there are often several candidate sources of yield data within each geography. Often, those different sources can differ considerably on their measurement of the same record. In Brazil, for example, there are two major sources providing historical yield records: 1) the Brazilian Institute of Geography and Statistics (IBGE); 2) Companhia Nacional de Abastecimento (CONAB) which is an official company of the federal government and is in charge of managing agricultural and supply policies. Although IBGE provides finer spatial resolution yield data, for municipios (akin to US counties), the quality of that data is a concern. Specifically, there are instances where many nearby counties are assigned the same yield even though satellite data indicates dramatically differing conditions. In addition, IBGE data are severely delayed in being released to the public, the most recent currently available yield records are often 2-3 years old.

Thus, in this example CONAB as the ground truth data source for Brazil. CONAB additionally provides monthly estimates throughout the growing season. For Argentina, the government source, ARMA (Argentinian Ministry of Agriculture) was used because there were no problematic sources of noise identified in the historical records. Additionally, alternative providers only provide data at a district level, making disaggregation for forecasting counties or states more difficult. Across both geographies, model performance is backtested against records from 2004 to 2019.

MODIS imagery is used in this example because it has several advantages, as follow.

Longitudinal coverage: MODIS data are available back to 2001 (although data from 2003 forward are used in this example to ensure the highest quality data, provided by coverage from both the Aqua and Terra satellites).

Daily revisit rate: MODIS provides imagery at a much higher temporal resolution (frequency) than most other satellite-borne sensors. Employing MODIS data provides daily views of crop growing regions, critical for compensating for lost imagery due to clouds and atmospheric interference.

Product maturity: The MODIS sensor has a strong reputation among academic researchers from a variety of disciplines. The high quality of MODIS' radiometry and calibration is well documented and there are a multitude of studies illustrating its utility in monitoring crop conditions.

Spatial resolution: The majority of the MODIS spectral bands used for monitoring vegetation have a spatial resolution of 500 meters. Although relatively coarse in the context of many other modern sensors (e.g., Sentinel 2, Landsat, etc.) this pixel size provides sufficient spatial granularity to accurately evaluate crop health at the scales of analysis for this example (county and above), while still providing a timely revisit rate.

MODIS data is sourced from a number of locations. This example uses the Nadir Bidirectional Reflectance (Distribution Function (BRDF)-Adjusted Reflectance (NBAR) product (MCD43A4) available from the NASA Land Processes Distributed Active Archive Center (LP DAAC) Distribution Server hosted at the USGS Earth Resources Observation and Science (EROS) Center. If the fully processed NBAR data are unavailable due to occasional lags in processing, missing data may be backfilled using a near real-time version of that product (MCD43A4N) available from NASA's EarthData portal.

As set out above, for exemplary US-based models, crop specific masks from USDA's Cropland Data Layer (CDL) are employed. However, there are no crop masks of a similar quality or granularity available in South America. The best available ones for Brazil are the 30 m resolution land cover maps from MapBiomas. While this is of a similar spatial resolution to the USDA's CDL, it doesn't provide crop-specific classifications, rather more coarse categories (e.g., perennial croplands) without indicating exactly what is being grown. Thus, in this example the same mask is used for full season corn and soybeans in Brazil (the MapBiomas perennial croplands layer). For safrinha corn, proprietary masks are used based on the MODIS NBAR product and area harvest reports. In Argentina, no public or open-source crop masks are available so a proprietary mask is also used.

As set out in previous examples, in some embodiments of the present disclosure, models use machine learning algorithms to generate county-level yield predictions from satellite, weather, and crop condition information data. County-level yield predictions are area-weighted to generate the national-level prediction. In the present example, features are determined from pixel-level data and national yield models are built from state-level data. In this example, linear models are used to aid in model interpretability.

In this example, the unit of observation for the models is a state rather than a country. This provides improved performance in national models. This improvement is due to the fact that the county (or municipio) level ground truth data in South America can be somewhat unreliable, as previously mentioned. Additionally, the complex cropping-system and the coarse crop masks also make the features at the finer spatial resolution noisy. As an example, while Brazil has 2300 municipios, it has only 20 states.

In some embodiments, to obtain forecast-ready data from satellite imagery it is first masked to focus only on those pixels associated with a crop of interest. Those data are then aggregated to a particular unit of geography (e.g., counties or municipios). These distilled signals for geographic areas are referred to as zonal summaries. Zonal summaries allow extraction of information from satellite imagery. However, the signal can suffer when (1) the crop mask is inaccurate or (2) multi-cropping strategies are used. For example, the maximum vegetation index (VI) achieved throughout the growing season is a particularly important feature for yield forecasting.

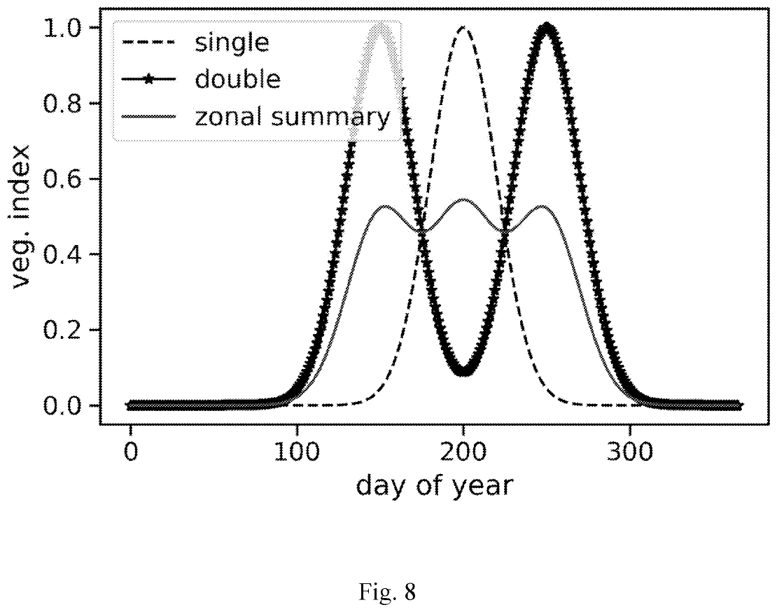

Referring to FIG. 8, consider a hypothetical situation where a county spans just two pixels (shown by the dashed and starred lines) that use single- and double-cropping with large differences in planting and harvest dates. The zonal summary process calculates statistics such as mean, variance and median for each day. The mean is plotted as a solid line. Extracting the maximum VI after zonal summary gives a value of 0.5 while the underlying pixel max VI should have been 1. Although this example is an extreme case, it illustrates that inaccuracies in the mask (including differently cropped pixels), large differences in phenology and the order of pixel aggregation can all significantly impact the resulting features calculated from zonal summaries.

In order to mitigate this, some embodiments employ a pixel sampling scheme to build features separately from the zonal summary pipeline. In this example, pixel locations were selected from South America crop masks by randomly sampling 200 pixels per state that were consistently labeled as cropland in the years of interest. These locations were fixed, and pixel level time series data were collected from 2003 to 2019 to be used as training data. At each day of year, the time series is smoothed, and the max VI is calculated from the start of the season defined as December 1 of the year before the harvest year. Given the sample of 200 max VIs per state, the median is then taken as the representative value for that geographic region for that day of year. The order of this aggregation avoids the pitfalls of zonal summaries as described above, and, secondly, the use of fixed pixel locations reduces the effect of noise in the crop mask which changes from year to year. It will be appreciated that a variety of pixel sampling methods may be used. In general, the count of sampled pixels represents a tradeoff between statistical significance and computational cost. Accordingly, for certain regions, fewer pixels may be sufficient, while in regions with great variation, more pixels may be required. Pixel sampling is particularly useful for regions with multiple growing seasons per calendar year (for example in South America), but may likewise be applied to other geographies, including those with single growing seasons.

The pixel sampling methodology described above provides better estimates of the max VI values and provides clean time series signals with which to identify key phenological indicators for the cropped areas. For Brazil, instead of relying on zonal summaries of the MODIS MCDQ12 product, in this example phenology periods are estimated through pixel sampling. In this example, the MCDQ12 phenology estimates are used for Argentina, as they are accurate enough in view of the simpler cropping system.

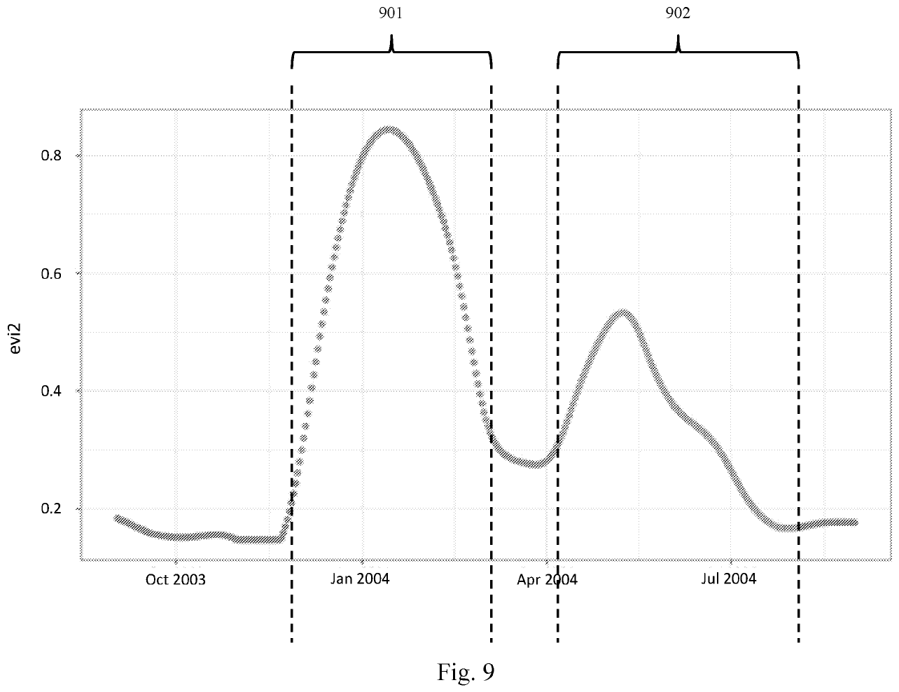

Referring to FIG. 9, an example EVI2 curve for a MODIS pixel in the 2004 growing season in Brazil is provided. A peak finding algorithm identifies time periods associated with peaks in the vegetation index (VI) curve. A variety of peak finding algorithms are known in the art, generally scanning a series for points that are greater than nearby points. Such scanning algorithms may be configured to detect peaks subject to peak height, peak width, or horizontal distance thresholds. Additional methods entail calculating the z-score of a point with respect to a moving mean and standard deviation. The VI curve illustrates standard double cropping practice in Brazil with an early soy crop (901) followed by a safrinha corn crop (902).

As noted above, a state-level unit of observation is used in this example. Adopting a coarse geographic region results in a decreased number of total observations. As the number of observations decreases, the risk of overfitting increases. In this example, a linear mixed effect model is used in place of a tree-based learning algorithm. Linear mixed effects (LME) models allow the addition of dependencies on certain categorical variables. For example, using a LME model allows the slope and/or intercept of the model to vary with state. This is beneficial because the relationship between a VI and the yield may differ by state as agronomic practices or general conditions change between states. However, it is disadvantageous to fit a separate regression line for each state independently, as it will further reduce the sample size and thus increase the model uncertainty. Instead, the LME model is able to constrain them following the same distribution, which provides the advantage of allowing the various states to borrow observational numerosity from each other.

The formula for a linear mixed effect model is given by Equation 3, where y is the response variable (yield) vector, β is a vector of fixed effects, u is a vector of random effects, X and Z are design matrices and ϵ is a vector representing the Gaussian noise. The Zu term allows for varying coefficients among the grouping factors.

y=Xβ+Zu+ϵ Equation 3

A linear mixed effect model of this form is used to generate state predictions. National predictions are built using an acreage weighted average as set out above. In brief, a linear model is built on top of the state forecasts to ladder them up (weighting based on historical production) to obtain the final national prediction.

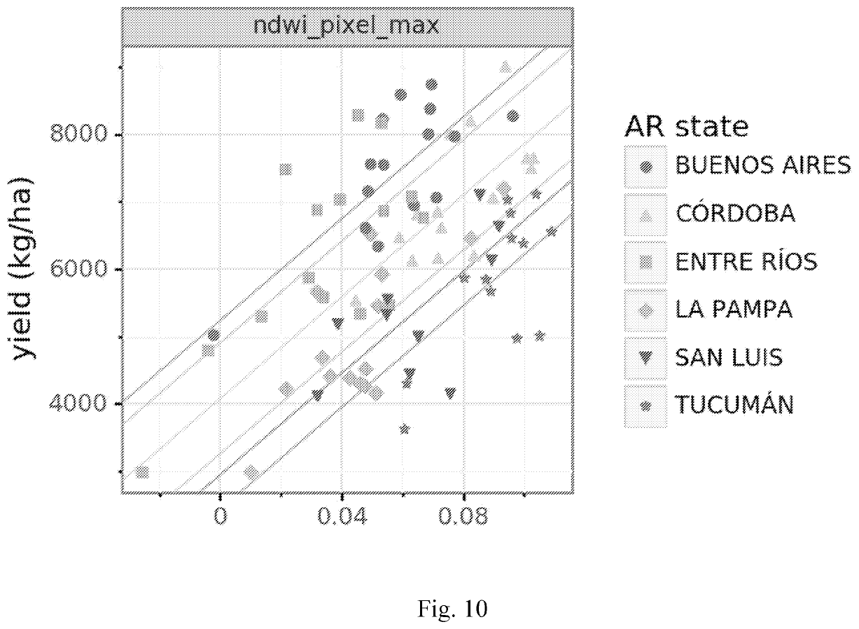

Referring to FIG. 10, the regression for the ndwi_pixel_max feature for the Argentina soy model is shown for several states. This example shows the fitting situation for a single feature. In this case a unique intercept is assigned for each state, but the slope is enforced to be constant among all states (fixed effect). Alternatives models may allow varying slopes among different states, at the risk of overfitting.

In this example, vegetation indices including EVI2, NDWI, NDVI, NDSW2, and CHI are used in combination with the single band SWIR2. Estimates of land surface temperature are also included. Anomalously high or low daytime and/or nighttime temperature can present unfavorable growing conditions, especially during critical parts of the growing season.

The satellite data coming from pixels and the zonal summary process are formatted as time series throughout the growing season while the target variable is a single end-of-season yield number. In order to align the data and to make useful features, temporal and spatial aggregation is used. Temporal aggregation includes, for example, splitting up the time series according to phenological periods and taking the mean or sum of the signal throughout the period. Assuming four phenological periods, this procedure can reduce a 200-day daily time series of a vegetation index (VI) to just four features (mean over first phenology period, vi_mean_p1, mean over second phenology period, vi_mean_p2, etc.). Another temporal aggregation is finding the max vegetation index over the season. This reduces a daily time series to just one number (vi_max). One or more of these strategies are used in various embodiments to distill time series data for better use in the linear models.

Spatial aggregation can be performed either before or after temporal aggregation. The use of pixel-level features reverses the order of aggregation from spatial-temporal (as in zonal summaries) to temporal-spatial (pixel-level features).

In this example, with combined feature creation from zonal summaries and pixel time series, over 200 features are obtained, although the number of features may vary from region to region. In the linear mixed effects model, features are selected with some to be considered as random effects. It will be appreciated that there are a variety of suitable automated or semi-automated feature selection methods known in the art, such as LASSO, forward feature selection, and tree-based methods.

In various embodiments, the models are updated throughout the growing season by including more features that capture how conditions are developing in the field. At the end of the season, the most fully-informed yield forecast is thus produced. For example, continuing the Argentina soy example, three sets of features are used throughout the season starting with an early season model which includes chi_zonal_max and ndwi_pixel_max, followed by a mid season model which adds ndvi_mean_p2, and finally the late season model which adds lstd_mean_p3 in April.

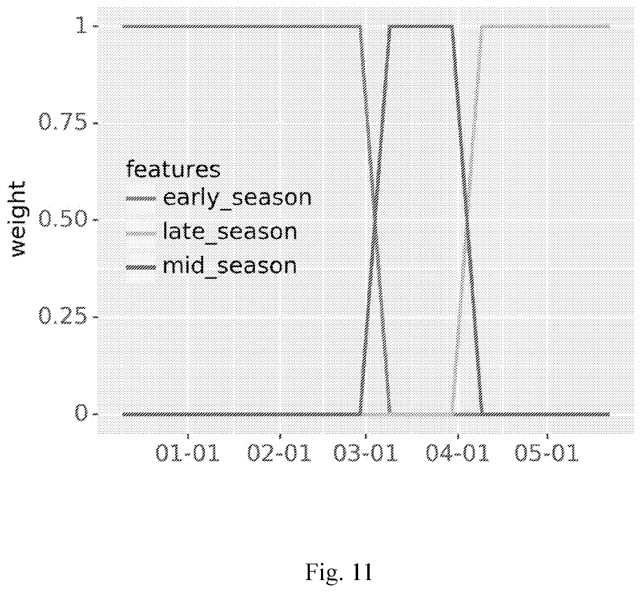

Referring to FIG. 11, a graph is provided showing the change over time of weights assigned to different collections of predictors over the course of the growing season. The ensemble weights of each model change throughout the season. The weights define how to take a weighted average of the individual state predictions to generate an ensemble state prediction. The national model is then built from the ensembled state predictions.

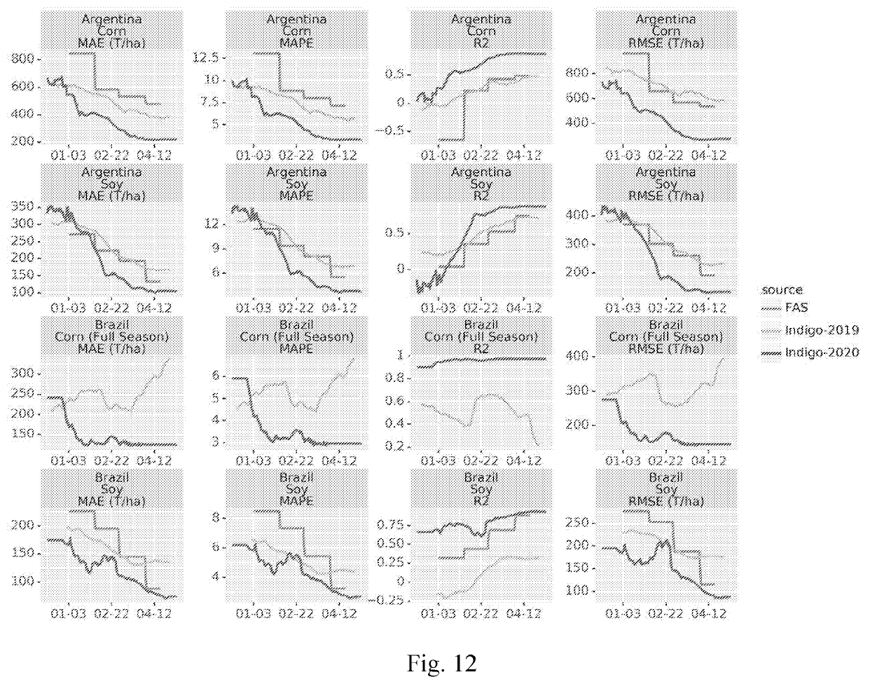

Model performance is assessed by performing leave-one-year-out cross validation and tracking metrics including mean absolute error, mean absolute percent error, r-squared, and root mean squared error. FIG. 12 contains plots for key model fit metrics derived from backtesting. These plots show the evolution of model performance through the growing season for all country and crop combinations. The plots show the improvement of the models over time and demonstrate a relative advantage over the USDA FAS forecasts.

The 2020 model outperforms the 2019 SA model especially later in the growing season. The model's error also falls below the FAS error. However, the FAS estimates correspond to leave-future-year out estimates, rather than the leave-one-year-out estimates of Indigo-2019 and Indigo-2020.

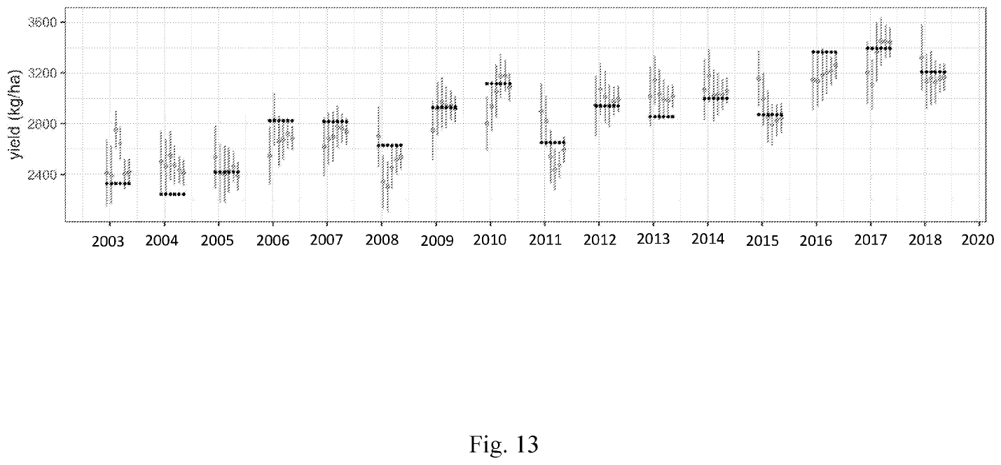

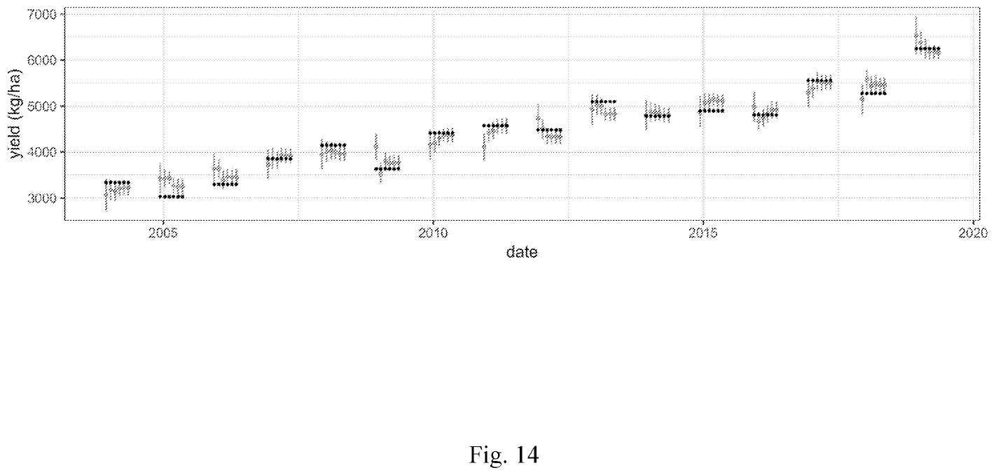

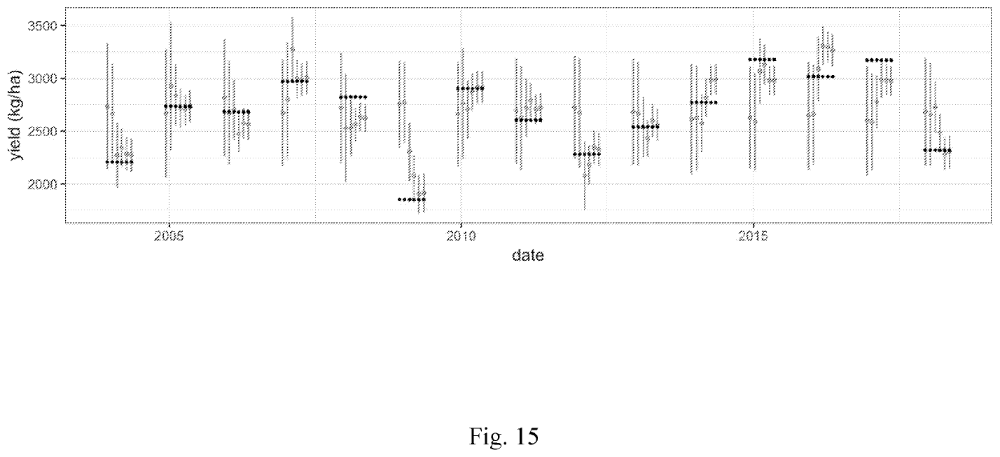

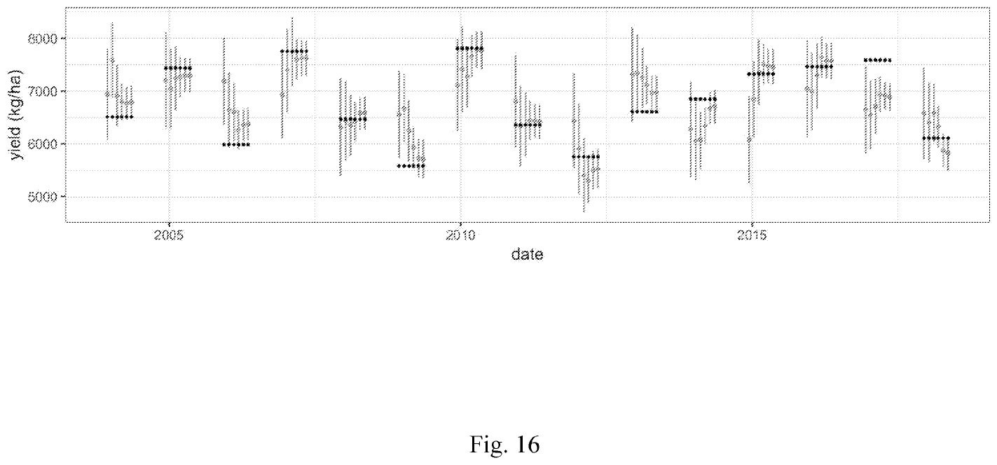

Monthly backtesting results (shown in FIGS. 13-16) also show model movement toward ground truth. For each year, the boxplots correspond to the months of the growing season in order—December, January, February, March, April, May. FIG. 13 shows data for Brazil soy. FIG. 14 shows data for Brazil full season corn. FIG. 15 shows data for Argentina soy. FIG. 16 shows data for Argentina corn. In each graph, black points indicate end-of-season ground truth data; colored points show model estimates from December to May along with uncertainty estimates. As the feature signal improves throughout the season, the prediction becomes more accurate and the model uncertainty decreases. Table 6 shows the end of season model performance for different regions and crops. MAE and RMSE values are given in kilograms per hectare.

TABLE 6

| | | MAE | MAPE | R2 | RMSE |
|---|---|---|---|---|---|
| Brazil | Soy | 73.92 | 2.71% | 0.93 | 87.36 |
| | Corn (Full) | 124.3 | 2.97% | 0.97 | 145.7 |
| Argentina | Soy | 104.1 | 3.75% | 0.87 | 133.7 |
| | Corn | 218.5 | 3.28% | 0.87 | 273.2 |

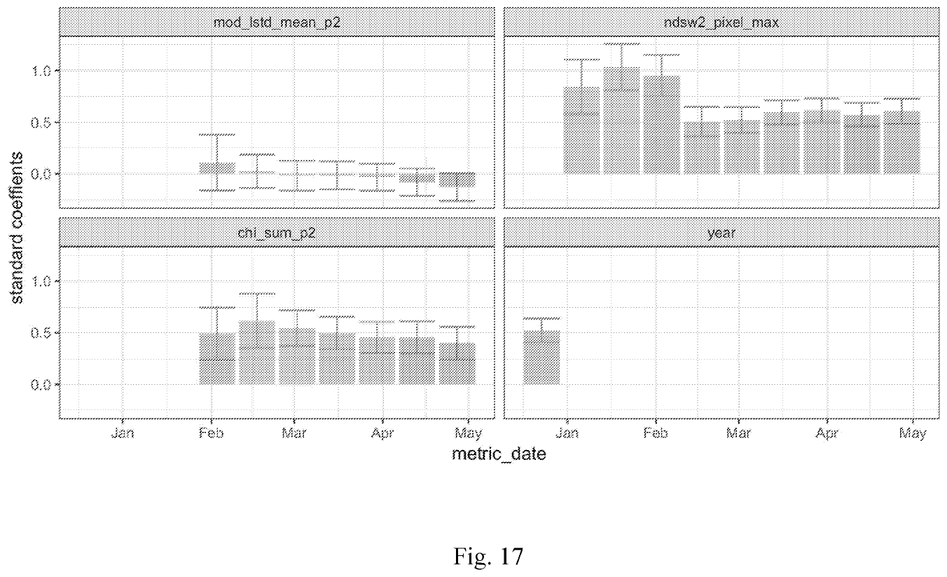

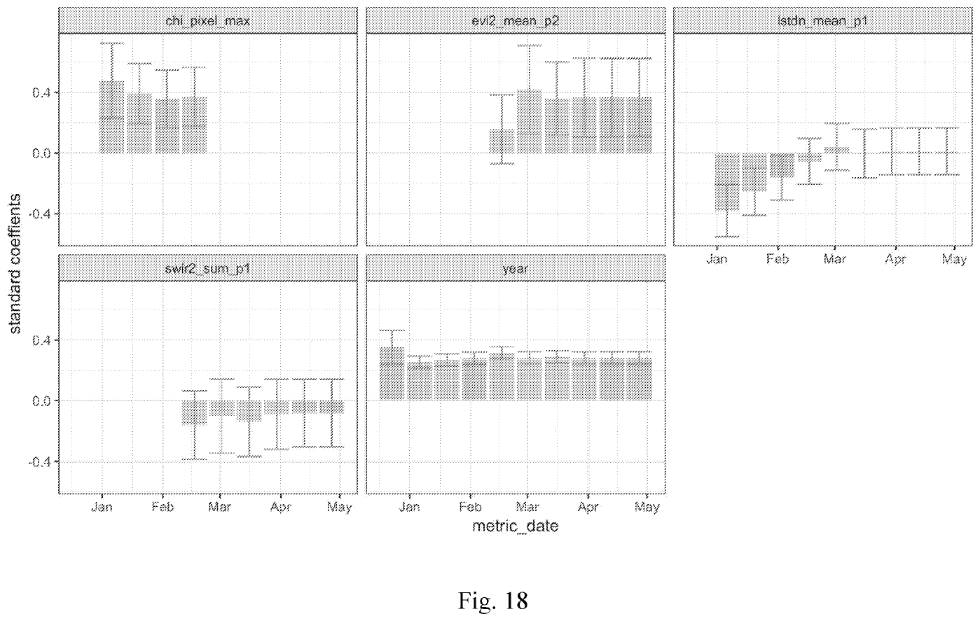

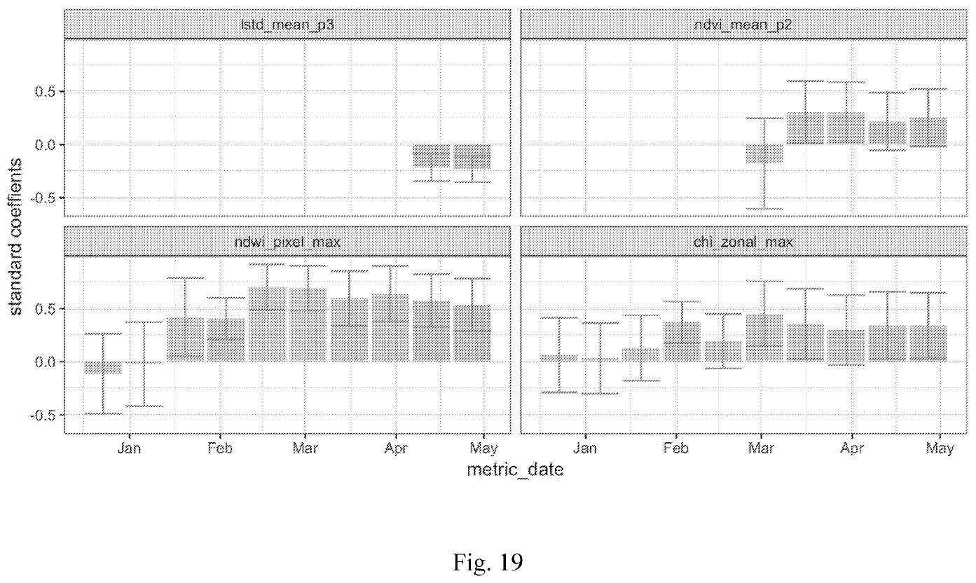

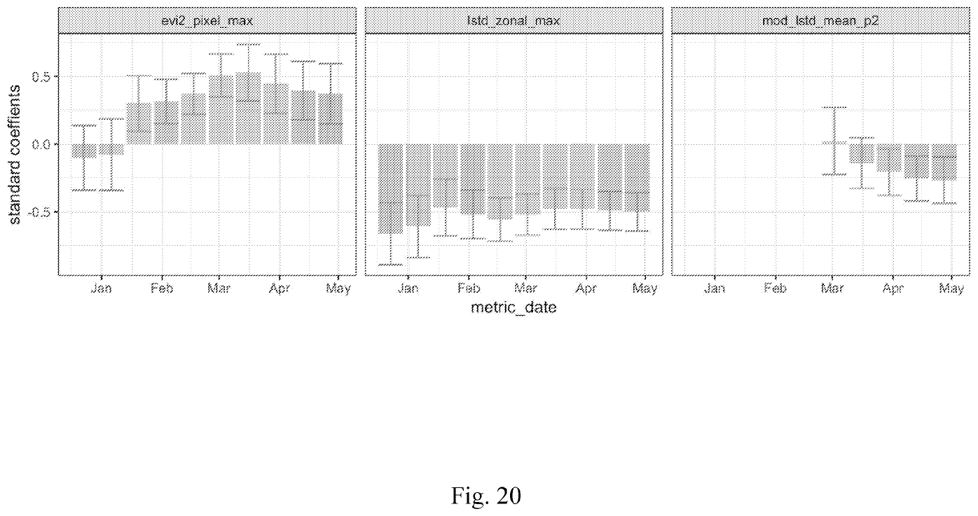

Linear models have interpretable coefficients which make them particularly suitable for use cases requiring transparency and model explainability. Plotting the standardized coefficients employed by the different forms of the model throughout the growing season in FIGS. 17-20 reveals the mean effect of each feature as a function of time along with a measure of the uncertainty in the mean effect. FIG. 17 illustrates Brazil soy. FIG. 18 illustrates Brazil full season corn. FIG. 19 illustrates Argentina soy. FIG. 20 illustrates Argentina corn.

A large positive coefficient implies that a small change in the feature corresponds to a large positive change in the estimated yield. A value of zero implies that the feature does not have a big impact on the yield. In the Argentina soy example, this is seen especially in the early season when features are not particularly informative. However, once the vegetation indices begin to pick up signal they become more important throughout the season (ndwi_pixel_max and chi_zonal_max, below). Additional features are added later in the season such as the mean of NDVI over the second phenological period (ndvi_mean_p2), and the mean of the daytime land surface temperature over the third phenological period (lstd_mean_p3). These coefficients and this particular graphical representation, combined with placing current conditions in a historical context will allow better explanation of why the models make the forecasts that they do over the course of the growing season.

### Field Scale Example

In this example, ground truth corn yield data from about 500 fields is used to predict field-scale yield with a relative error rate around 18%. The methodology makes use of linear models built on satellite-derived vegetation indices (VIs) to make forecasts. The most predictive feature is derived by taking the maximum VI throughout the season.

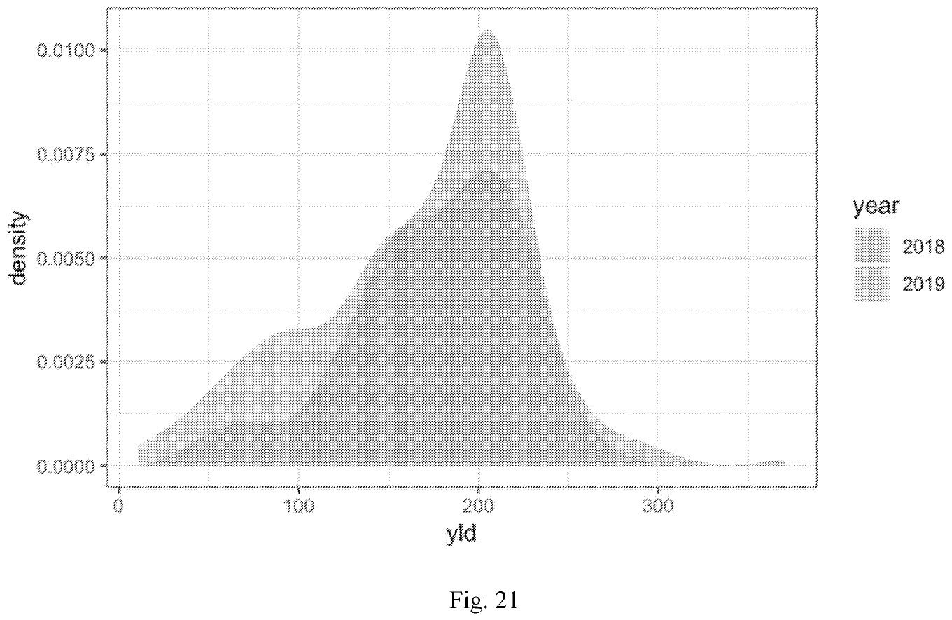

Data were sourced manually from existing commercial fields. Training data spanned two years, with 215 fields in 2018 and 293 fields in 2019. The yield distributions are presented in FIG. 21. It will be apparent that 2018 was a better year than 2019, which was heavily impacted by late planting and early flooding.

Lack of training data is an impediment to building robust models. Table 7 shows how the data are spread spatial and temporally in this example. Some important corn producing states only have one year of data, for example, IA, NE, MN. Leave one year out cross validation is used, as in prior examples. Thus, the limitation of the data avoids using the state as a feature, which could be a good approximation of some missing practice information.

TABLE 7

| | AR | CO | IA | IL | IN | KS | KY | MN | MO | MS | NE | OH | OK | PA | SD | TN |
|---|---|---|---|---|---|---|---|---|---|---|---|---|---|---|---|---|
| 2018 | 2 | 2 | 11 | 57 | 84 | 22 | 24 | 0 | 3 | 7 | 0 | 1 | 1 | 1 | 0 | 0 |
| 2019 | 11 | 5 | 0 | 39 | 7 | 50 | 5 | 17 | 55 | 0 | 50 | 31 | 6 | 0 | 7 | 10 |

There are several challenges when working with field scale data which contribute as sources of error in the final models. Field boundaries may include non-cropped areas which may contaminate the satellite signal. For example, if forest or standing water are included in the field boundaries the vegetation indices can be dramatically shifted. Secondly, there exist inherent error in the yield measurement itself. Whether the yield was calculated via scale tickets or on the combine, we expect a certain degree of error in the yield measurement.

As discussed above, various satellite platforms can be used for predicting crop health at the field scale. Each platform represents different tradeoffs. For example, MODIS has the highest revisit rate, but lowest spatial resolution. HLS combines Landsat and Sentinel-2 to increase the temporal resolution, however, the product only traces back to 2015.

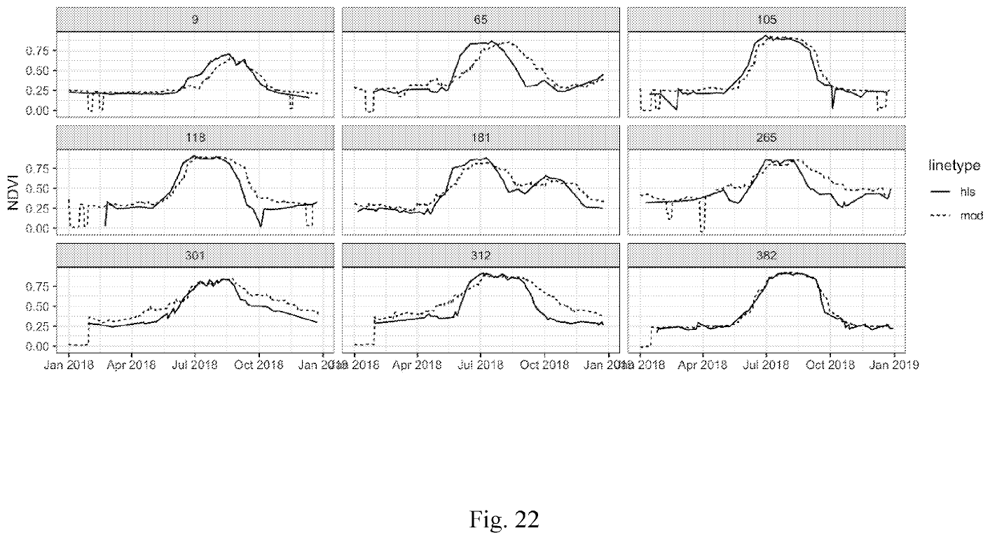

Exemplary HLS and MODIS time series are shown in FIG. 22, which shows the normalized difference vegetation index (NDVI) time series for a sample of nine fields throughout 2018. The distinctive shape of the curves is common among corn and soy fields, and it reflects the changes in plant phenology throughout the season. For most cases, the peak values from the two platforms are aligned. In some location (265,312), MODIS tend to have broader shoulders than the HLS time series, likely due to the coarse spatial resolution of the MODIS, resulting in including non-cropped area. In other locations, the NDVI values of the HLS and MODIS sensor display a large discrepancy between the HLS and MODIS values in the middle of the growing season. In such locations, with HLS shows much higher values. It is likely that the MODIS signal, due to lower spatial resolution contains signal arising from non-cropped regions adjacent to the field.

However, HLS is not superior in all cases. Low revisit rates can harm the signal, resulting in missing HLS data. In particular for this location, HLS missed the peak growing season. Accordingly, in this example, both data sources are used to improve coverage and performance.

At the county/regional scale, the noise in the remote sensing signals can be alleviated by spatial aggregation. However, spatial aggregation is not available at the field scale. In addition, the signal can be more impacted by atmosphere contamination. Thus, proper data cleaning becomes more important at the field scale.

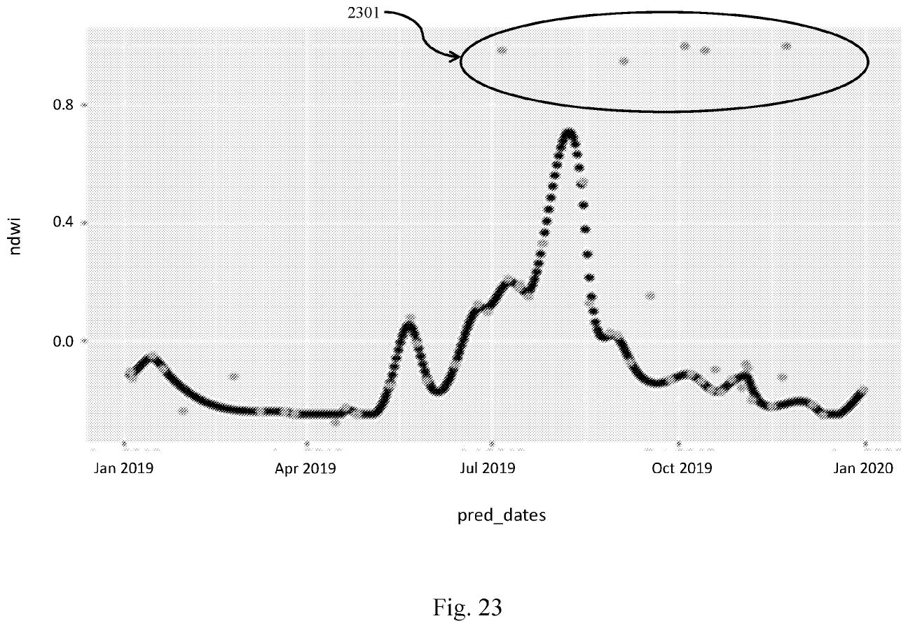

Referring to FIG. 23, exemplary ndwi data are shown for a one year period. In this example, filters are applied to remove the abnormal data points 2301. The time series is fit to a smooth curve, which can fill the missing values due to clouds and other confounders. In this example, the signal is further denoised. It will be appreciated that a variety of techniques are suitable, including scatterplot smoothing methods such as LOESS (locally estimated scatterplot smoothing), or spline methods such as cubic spline.

As in prior examples, different features are extracted from the raw remote sensing time series. In particular, peak values of the vegetation index are most correlated with yield. The process was repeated for many of the most studied vegetation indices, and the correlation between peak VI and yield are shown in Table 8.

TABLE 8

| Feature | Correlation |
|---|---|
| hls_ndwi | 0.758 |
| hls_ndsw2 | 0.758 |
| hls_ndvi | 0.747 |
| hls_evi2 | 0.680 |
| mod_ndsw2 | 0.664 |
| mod_evi2 | 0.637 |
| mod_ndvi | 0.618 |
| mod_ndwi | 0.616 |
| mod_chi | 0.614 |

One challenge with deriving the peak vegetation index values from remote sensing time series is defining the timing of the growing season. In some cases, due to cover crops and double-cropping practices there are two or more peaks in the VI signal throughout the year. Thus, building a yield model that relies on the peak VI requires the identification of the correct peak during the season. In some embodiments, automated cycle identification algorithms may be used to split a season up into segments, each containing a single peak in the VI time series. However, noisy signals may pose a challenge to such approaches.

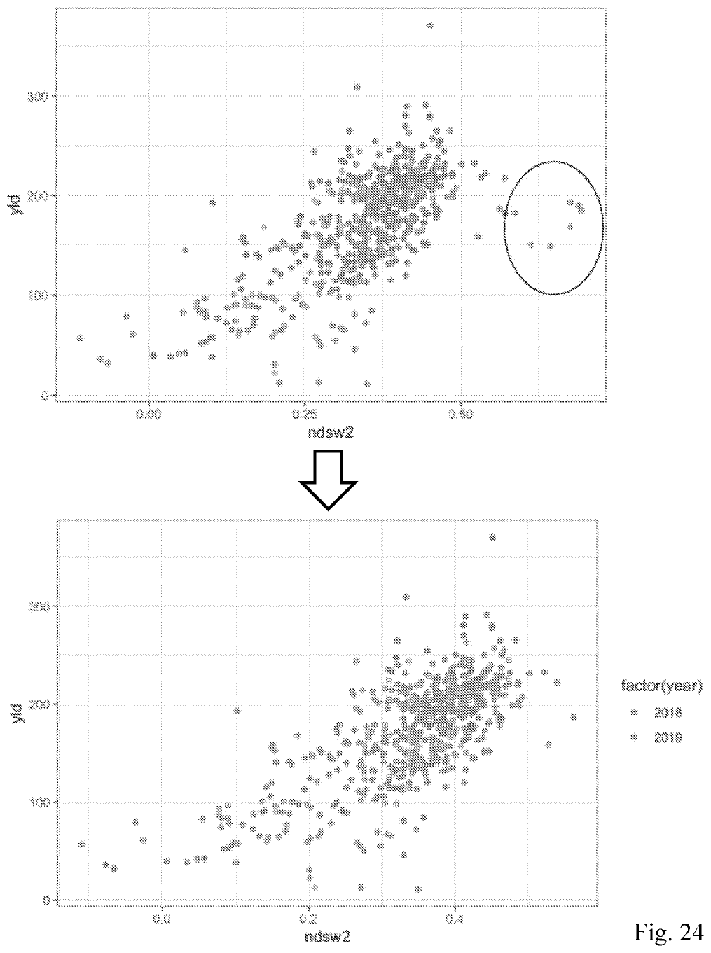

Exemplary yield data are shown in FIG. 24. Using grower practice information regarding planting and harvest dates improves phenology detection by correcting outliers in the peak VI values. The result of peak VI extraction based on automated phenology detection is shown in the top graph. Many observations have large peak VI values but relatively small yields, which indicates a problem with the feature extraction method. However, as shown in the bottom graph, grower-provided planting information improves peak extraction and allows correction of outliers.

In some embodiments, where practice data is not available. Automated practice classification may be used.

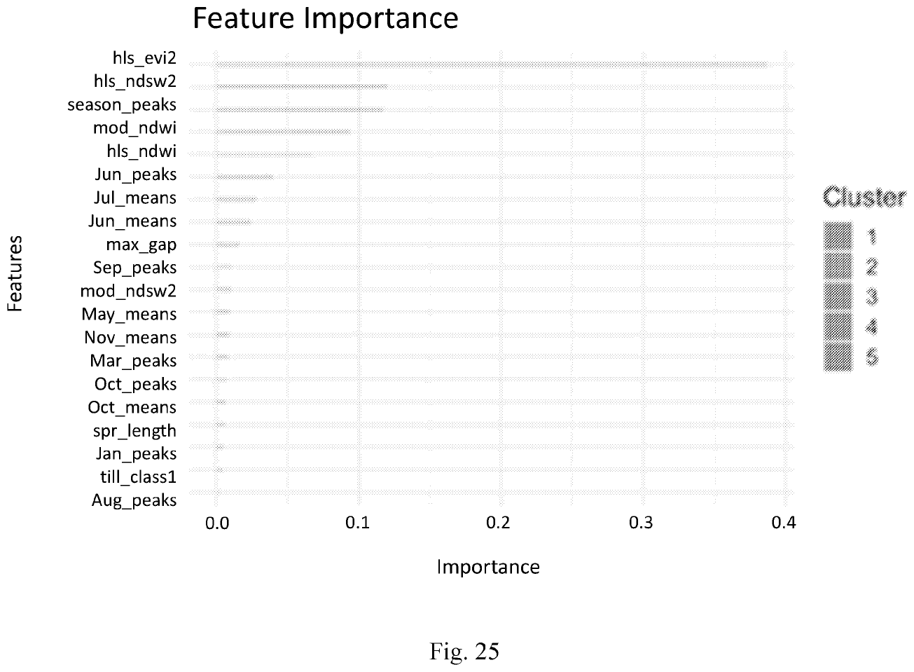

Based on exemplary field data, two different regression methods are illustrated below: linear models with feature selection; XGBoost for all created features (HLS, MODIS max VI; features from the regen-pipeline). For the linear models, the combination of hls_ndwi and mod_ndsw2 gives best cross validation results. In the XGBoost model, the feature importance are shown in FIG. 25. The estimated tillage class and cover crop type do not help to increase the prediction power much (ranking very low) for this dataset.

Table 9 gives the comparison between the two approaches. In this case, the linear approach shows the best performance. However, performance will vary among datasets. MAE and RMSE values are in bushels per acre.

TABLE 9

| | # of features | MAE | RMSE | R2 | MAP |
|---|---|---|---|---|---|
| Linear | 2 | 25.5 | 34.1 | 0.59 | 18.5 |
| Xgboost | 41 | 26.4 | 34.5 | 0.58 | 18.4 |

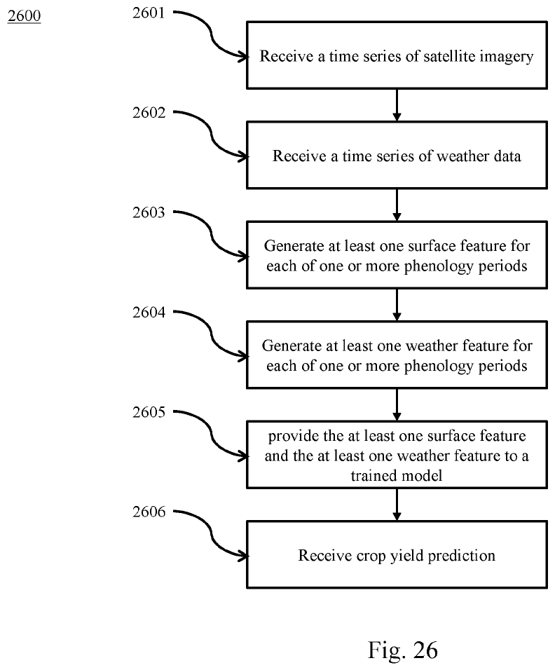

Referring now to FIG. 26, a method of predicting crop yield of a geographic region is illustrated according to embodiments of the present disclosure. At 2601, a time series of satellite imagery is received. The time series of satellite imagery covers at least the geographic region during a predetermined time period. The predetermined time period comprises one or more phenology periods. At 2602, a time series of weather data is received. The time series of weather data covers at least the geographic region during the predetermined time period. At 2603, at least one surface feature of the geographic region during each of the one or more phenology periods is generated from the time series of satellite imagery. At 2604, at least one weather feature of the geographic region during each of the one or more phenology periods is generated from the time series of weather data. At 2605, the at least one surface feature and the at least one weather feature are provided to a trained model. At 2606, a prediction of crop yield for the geographical region is received from the trained model.

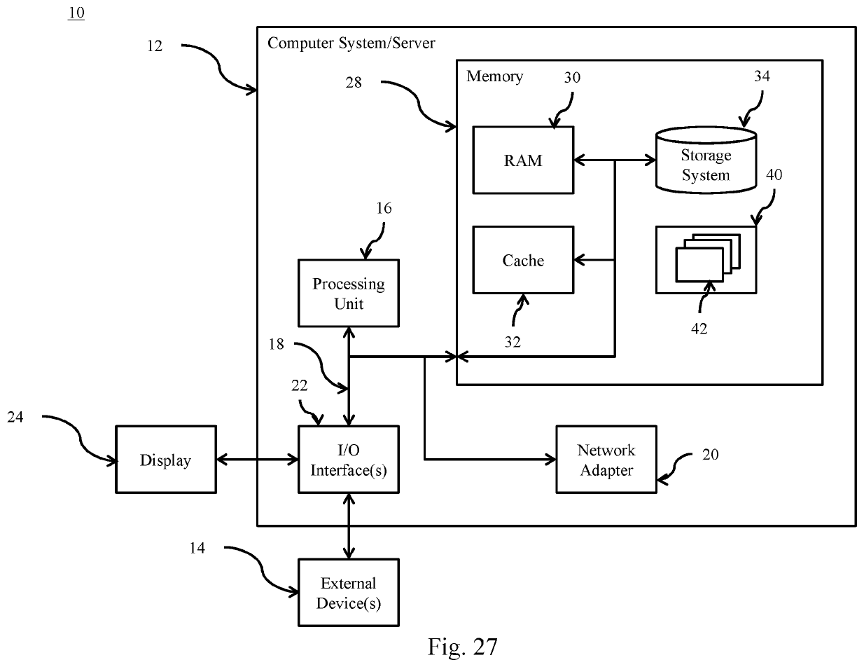

Referring now to FIG. 27, a schematic of an example of a computing node is shown. Computing node 10 is only one example of a suitable computing node and is not intended to suggest any limitation as to the scope of use or functionality of embodiments described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 27, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for predicting crop yield of a geographic region, the method comprising:
receiving a time series of satellite imagery, the time series of satellite imagery covering at least the geographic region during a predetermined time period, the predetermined time period comprising one or more phenology periods;
receiving a time series of weather data, the time series of weather data covering at least the geographic region during the predetermined time period;
generating from the time series of satellite imagery at least one surface feature of the geographic region during each of the one or more phenology periods;
generating from the time series of weather data at least one weather feature of the geographic region during each of the one or more phenology periods;
providing the at least one surface feature and the at least one weather feature to a trained model;
receiving from the trained model a prediction of crop yield for the geographical region.

2. The method of claim 1, wherein generating the at least one surface feature comprises generating summary data of the satellite imagery within the geographic region.

3. The method of claim 2, wherein generating the at least one surface feature further comprises aggregating the summary data within each of the one or more phenology periods.

4. The method of claim 2, wherein generating the at least one surface feature further comprises sampling a plurality of pixels of the satellite imagery within the geographic region and generating summary data therefrom.

5. The method of claim 4, wherein the summary data comprises a maximum vegetation index.

6. The method of claim 1, wherein generating the at least one weather feature comprises generating summary data of the weather data within the geographic region.

7. The method of claim 6, wherein generating the at least one weather feature further comprises aggregating the summary data within each of the one or more phenology periods.

8. The method of claim 1, wherein the trained model comprises a linear mixed-effects model or a decision tree ensemble.

9-15. (canceled)

16. The method of claim 1, further comprising:
determining a prediction of crop yield for at least one additional geographic region;
aggregating the prediction of crop yield for the geographical region and the prediction of crop yield for the at least one additional geographic region.

17. The method of claim 16, wherein aggregating comprises weighting the prediction of crop yield for the geographical region according to a size of the geographical region and weighting the prediction of crop yield for the at least one additional geographic region according to a size of the at least one additional geographic region.

18. The method of claim 16, wherein aggregating comprises weighting the prediction of crop yield for the geographical region according to crop production area within the geographical region and weighting the prediction of crop yield for the at least one additional geographic region according to crop production area of the at least one additional geographic region.

19. The method of claim 16, wherein aggregating comprises weighting the prediction of crop yield for the geographical region according to historical yield of the geographical region.

20. (canceled)

21. The method of claim 1, further comprising dividing the predetermined time period into the one or more phenology periods based on the time series of satellite imagery, and wherein dividing the predetermined time period comprises
determining a time series of vegetation indices based on the time series of satellite imagery; and
locating peaks in the time series of vegetation indices.

22. The method of claim 1, further comprising dividing the predetermined time period into the one or more phenology periods based on the time series of satellite imagery, and wherein dividing the predetermined time period into the one or more phenology periods comprises:
sampling a plurality of pixels of the time series of satellite imagery;
determining a time series of vegetation indices based on the sampled pixels; and
locating peaks in the time series of vegetation indices.

23. (canceled)

24. The method of claim 1, further comprising selecting the at least one surface feature and the at least one weather feature based on the one or more phenology periods, and wherein selecting the at least one surface feature and the at least one weather feature comprises determining a performance gain attributable to each of the at least one surface feature and the at least one weather feature each of the one or more phenology periods.

25. The method of claim 24, wherein determining the performance gain comprises applying a decision tree ensemble.

26. The method of claim 1, further comprising selecting the at least one surface feature and the at least one weather feature based on the one or more phenology periods, and wherein the one or more phenology periods comprise a plurality of phenology periods, and wherein the selection of the at least one surface feature and the at least one weather feature varies over the predetermined time period.

27. The method of claim 1, further comprising:
applying a crop mask to the time series of satellite imagery prior to generating the at least one surface feature.

28. A system comprising:
a computing node comprising a computer readable storage medium having program instructions embodied therewith, the program instructions executable by a processor of the computing node to cause the processor to perform a method comprising:
receiving a time series of satellite imagery, the time series of satellite imagery covering at least the geographic region during a predetermined time period, the predetermined time period comprising one or more phenology periods;
receiving a time series of weather data, the time series of weather data covering at least the geographic region during the predetermined time period;
generating from the time series of satellite imagery at least one surface feature of the geographic region during each of the one or more phenology periods;
generating from the time series of weather data at least one weather feature of the geographic region during each of the one or more phenology periods;
providing the at least one surface feature and the at least one weather feature to a trained model;
receiving from the trained model a prediction of crop yield for the geographical region.

29-54. (canceled)

55. A computer program product for predicting crop yield of a geographic region, the computer program product comprising a computer readable storage medium having program instructions embodied therewith, the program instructions executable by a processor to cause the processor to perform a method comprising:
receiving a time series of satellite imagery, the time series of satellite imagery covering at least the geographic region during a predetermined time period, the predetermined time period comprising one or more phenology periods;
receiving a time series of weather data, the time series of weather data covering at least the geographic region during the predetermined time period;
generating from the time series of satellite imagery at least one surface feature of the geographic region during each of the one or more phenology periods;
generating from the time series of weather data at least one weather feature of the geographic region during each of the one or more phenology periods;
providing the at least one surface feature and the at least one weather feature to a trained model;
receiving from the trained model a prediction of crop yield for the geographical region.

56-81. (canceled)
